(19) United States
(12) Patent Application Publication
(10) Pub. No.: US 2025/0285198 A1
(43) Pub. Date: Sep. 11, 2025

(54) Systems and Methods for Automating Dynamic Sourcing

(71) Applicant: ViaSat, Inc., Carlsbad, CA (US)

(72) Inventors: Annette M. Romo, Phoenix, AZ (US); Robert W. Mac Kay, Carlsbad, CA (US); Kyle J. Corcoran, Las Vegas, NV (US); David A. Degrose, Peoria, AZ (US); Matthew D. Gutekanst, Scottsdale, AZ (US)

(21) Appl. No.: 18/861,197

(22) PCT Filed: Apr. 28, 2023
(86) PCT No.: PCT/US2023/020498

§ 371 Date: Oct. 28, 2024

Related U.S. Application Data
(60) Provisional application No. 63/336,298, filed on Apr. 28, 2022.

(51) Int. Cl. G06Q 50/04; G06Q 10/0635

(52) U.S. Cl. CPC G06Q 50/04; G06Q 10/0635

(57) ABSTRACT

A technology is described for communicating a supplier action selected for defective feature correction. The method can include receiving a defective feature and risk attributes for a part incorporated into a product. An additional operation may be determining a risk priority rating by combining the risk attributes. The risk priority rating may be mapped to the supplier action by determining a risk priority rating range, from a plurality of risk priority rating ranges with associated supplier actions, within which the risk priority rating is classified. A message may be sent to a supplier with the supplier action to be taken for a defective feature.

### PRIORITY CLAIM

This patent application claims priority to provisional patent application 63/336,298 filed on Apr. 28, 2022 with the title “SYSTEMS AND METHODS FOR AUTOMATED REQUIRED SUPPLIER ACTIONS” which is incorporated by reference herein.

### BACKGROUND

Manufacturing of physical products, such as electronics, communications equipment, vehicles, tools, or even household goods, is often performed in a factory. The final assembly of a product may be a combination of a number of sub-parts or sub-components that are received by a main supplier (e.g., the assembler or main manufacturer) from sub-suppliers such that the final product may be provided to customers (e.g., a contracting customer or an end user customer). As such, the quality of the parts from the sub-suppliers may affect the overall final product quality, cost, delivery, timing and ultimately outcome.

When the main supplier receives parts from the sub-suppliers, the parts may be inspected for defects. In addition, defects in the parts may be detected when the parts are being assembled into the main supplier's final product. When defects are detected by an engineer, manager or assembler, they may be classified and documented. Then the engineer or manager may notify suppliers (e.g., call or personally write an email) about the defects that were found and documented. The suppliers may then return to their production line and try to contain the defects or fix the problem that is creating part defects. Once the problem has been identified and potentially rectified, then the parts supplier may report to the product manufacturer at the supplier's own discretion. This overall process may be slow and susceptible to errors, while the corrections made to the supplier's parts may only happen slowly over time. As a result, manufacturing processes or supply chains can be difficult to manage and bring to maturity.

### BRIEF DESCRIPTION OF THE DRAWINGS

FIG. 1 is a block diagram illustrating an example of a system for communicating a supplier action selected for correcting defective parts that are being manufactured and for monitoring communications from suppliers, supplier devices and Internet-of-Things (IoT) manufacturing machines.

FIG. 2 is a chart illustrating an example of defect data that can be collected and refined in order to more automatically work toward a quality product.

FIG. 3 is a block diagram illustrating an example of an automated flow for assigning supplier actions.

FIG. 4 is a diagram illustrating an example portion of a table for defect data including defective feature and defect.

FIG. 5 is an example chart illustrating defect metric trends.

FIG. 6 is an example chart depicting a test failure defect count and yield trending chart for defective feature/defects.

FIG. 7 is a table illustrating an example of the risk attributes of severity, occurrence and detection which can be used to calculate a risk priority rating that is a risk priority number (RPN) for defective features/defects.

FIG. 8 illustrates that the risk priority rating (e.g., RPN) calculated from the risk attributes may be mapped to a supplier action level.

FIG. 9 illustrates an example of progressive supplier action levels for defective features/defects based on a count of defects in a multiple week period and corresponding severity and detectability attributes.

FIG. 10 illustrates an example of a quality effectiveness scorecard and supplier response date coding.

FIG. 11 is a flow chart illustrating an example of a method for displaying a supplier action in response to a defective feature/defect notification using the graphical user interface of FIG. 10.

FIG. 12 illustrates an example of a flow chart for the assignment of supplier action dates when no date already exists.

FIG. 13 illustrates an example of a flow chart for the changing of dates with new supplied dates from a supplier, when a date already exists.

FIG. 14 is a flowchart illustrating an example of changing dates for supplier actions that are ineffective, where dates already exist.

FIG. 15 illustrates an example graphical user interface for managing a plurality of suppliers that supply parts for an assembled product.

FIG. 16 is a flowchart illustrating an example method of communicating a supplier action selected for defect correction.

FIG. 17 is a block diagram of a service provider environment according to an example of the present technology.

FIG. 18 is a block diagram that provides an example illustration of a computing device that may be employed in the present technology.

### SUMMARY

A method may be provided for communicating a supplier action selected for defect correction. One operation may be receiving or retrieving defect data and defect risk attributes associated with one or more defects for a part in a product. A risk priority rating for the defect may be determined by combining the defect risk attributes. The risk priority rating may be mapped to the supplier action using a mapping function to identify the supplier action for correcting the defect. A message may be sent to a supplier with the supplier action to be performed to correct the one or more defects.

A method for displaying supplier response to a defective part notification using a graphical user interface is described. A defect may be identified for a defective feature of a part used in assembling a product. An action completion date may be displayed as a calendar due date for a supplier action for the defect. An action state color may be applied to the calendar due date for the supplier action. A message may be received from a supplier at a monitoring service for the supplier action which has been completed. An action completed color associated with the calendar due date which the supplier has completed may be displayed as directed by the monitoring service.

A method is provided for managing a plurality of suppliers that supply parts for a product using a graphical user interface. One operation may be identifying a plurality of defects of the product for which suppliers have been assigned supplier actions. Another operation may be determining a supplier maturity metric for a supplier using risk priority ratings for the plurality of defects associated with the supplier. A tree graph may be displayed, and a node of the tree graph represents the supplier of a product part and an edge of the tree graph represents a product part movement. The supplier maturity metric and a graphical user interface control associated with the supplier may also be displayed. An activation of the graphical user interface control may be received to initiate a remedial action associated with the supplier.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

The present technology provides dynamic sourcing and management for manufacturing processes through which a product may be manufactured from multiple parts provided by a number of suppliers. In one embodiment of the technology, systems and methods can be provided for automating the selection and communication of supplier actions requesting corrections to be made to a defect of a part or component. The defect of the part can be identified by an agent (e.g., a hardware agent, a software agent, an Internet-of-Things (IoT) manufacturing device, supplier devices, sensor enabled devices, etc.) of, for example, a customer (e.g., a product manufacturer). The supplier actions may indicate what actions a supplier of the part is requested (or required) by the customer to perform to correct the defect of the part.

As used herein, a defective feature may be defined as a characteristic, component, part, or aspect of a product that may experience or include one or more defects. Examples of defective features may include connector pins or a connector body of a cable, chassis or cover of an enclosure, and so forth. In some instances, defective features may correspond to software components or features that include one or more software-based defects. A defect may be defined as when the defective feature is out of specification or as what is wrong with the defective feature. Examples of a defect can be a bent connector (defect) of a pin (defective feature) or an edge burr or burn mark (defects) on the chassis or cover (defective feature). A software component may experience software-based defects such as improper settings, errors in code, and the like. Thus, defects may be, or otherwise make the part including the defective features and defects non-conforming to corresponding specifications, drawings, or contract requirements. A defect may be further defined as any identified problem with a part, manufacturing settings, software components, manufacturing hardware performance problem or software performance problem. More specifically, each defective feature may have one or more multiple defects. While examples herein may describe parts provided by suppliers as if they are physical parts, the parts that include defective features and/or defects may similarly be or otherwise comprise non-physical components, such as software modules and the like. The term customer can be defined here as: an intermediate customer assembling the product, a customer who designed the product or a final end user of the product. As used herein, the defective feature and defect may both be used to identify a defect that the supplier may be requested to correct. For example, to fully identify what a supplier is requested to correct, the customer may indicate both the defective feature and the defect, where the defect is the defect affecting the paired defective feature (i.e., the defective feature/defect pairing referenced herein) to the supplier, as described further below. Thus, the phrase defective feature/defect may refer to a defective feature or a defect or both a defective feature and a defect of a part, while the phrase defect information or defective feature data refers to information or data regarding one or both of the defective feature and the defect. In some embodiments, a defective feature may be attributed to a particular supplier such that only defective feature data associated with that defective feature is corresponds to that supplier. Such an association may enable simplified processing of defective feature data specific to a particular supplier, including trending data, metric data, and the like.

The defective features/defects of parts (hardware-or software-based defective features/defects) may be identified by computing devices in communication with hardware or software sensors associated with customer and/or supplier devices, IoT enabled devices (e.g., IoT manufacturing machine), data collection devices, and/or any sensor enabled computing device. Such computing devices may also capture or otherwise determine a classification and/or description data for the defective features/defects of a part. Supplier devices at or of suppliers may receive automatically generated defect notifications, trending defect reports, and feedback regarding: the defective features/defects identified, the supplier actions and/or effectiveness of implemented corrections. The automated system and method may continually assess supplier performance and risk for each defective feature/defect of a part or a product and then issue progressive levels of supplier actions (e.g., supplier response requests) to supplier of the part to ensure effective follow-up.

The present technology provides a system and method to automatically capture supplier related defective features/defects in real-time or near real-time and quickly notify suppliers of issues as they are occurring. In turn, this may reduce correction cycle times by providing defect information to suppliers more quickly. For example, defective features/defects can be identified and/or categorized by computing devices with sensors (e.g., hardware or software sensors), customer and/or supplier devices, machine learning, IoT enabled devices (that can test or use a product), IoT manufacturing devices or similar automated detection means such that corresponding defect information is stored into an electronic data storage system.

The categorization of the defective features/defects can enable or include a count of the defect features/defects made over time. Accordingly, the supplier may receive immediate or near real-time electronic notice of the defects discovered in a part provided by the supplier, along with the categorization of the defects and photos of the defects and/or defective features provided in a shared location. The system and method can define or assign supplier actions to be taken by the supplier to correct the defects. Additionally, the extent of the supplier actions may be driven in part by, for example, risk attributes (including a number of repeated defects (e.g., the same or different defects), a severity of the defects, a detectability of the defects) and/or undesirable performance attributes that occur in the manufacturing process for a given defective feature.

Supplier actions for defective features/defects of parts may employ various types of corrective actions that the customer wants the supplier of the parts to perform (e.g., to cause the parts provided by the supplier to be conforming to corresponding specifications, drawings, or contract requirements, etc.). Examples of the corrective actions a supplier may be asked to perform to correct a defect may include: 1) containment without reporting to the customer, 2) containment and reporting to the customer, 3) fixing the cause of the problem and reporting to the customer, and 4) performing a quality control process to fix the defect and process (e.g., undertaking a CAR/8D process-a quality control method developed by Ford Motor Company that follows eight disciplines).

Defect risk attributes (the risk attributes) may also be used to determine what the impact of a defective feature/defect of or in a part is upon a customer or final product. In one example, the risk attributes may be a) detectability, b) severity, and c) occurrence. The detectability attribute may represent how easily a defect of a defective feature in a part can be identified. The occurrence attribute may represent a quantity of occurrences, a frequency of occurrences, or a current ranking of occurrences (e.g., high, medium, low or a 1 to N ranking). The severity attribute may represent an impact of the defect of the defective feature to or on a customer. For example, the severity may represent broad or more narrow aspects of the supply chain or entities in the supply chain that may affected, such as impact on: product performance, delivery timing, cost, market share impact on the end customer, impact on suppliers higher in the supply chain, etc. In one example, some businesses may tolerate a high scrap rate for a part, and for other businesses, the development or delivery cycle time may need to be short instead. The severity attribute may help capture and manage such business impacts or risks flowing from the defective features/defects.

Another type of risk attribute may be a performance attribute. Performance attributes may refer to measurable attributes that represent performance ranges and other manufacturing performance aspects and functions. In one example, performance attributes may represent how closely a part conforms to certain values or parameter ranges for a part. For example, automated feedback may indicate that the parameter ranges for a part being manufactured are drifting to a failure limit. Performance attributes that represent a parameter range can also be a manufacturing process indicator or a software process indicator.

In another example of performance attributes, a statistical capability analysis may be performed. This analysis may describe the probability that the parts being produced may or may not conform to the defined specifications. A specification range may be determined and a historical population of a continuous value (e.g., a length) may be collected. The continuous value may have a mean, a standard deviation, and related statistical analysis. This performance attribute is not a Boolean value or an enumerated value but the performance range identifies part of the risk that can be used for statistical process control. The performance attribute may have upper and lower control limits and/or specification limits. Such performance attribute ranges may also apply to manufacturing capability analysis used to assess the capability of a supplier. These control limits and specification limits may be monitored and as more sample readings from parts or processes are received that are approaching an upper and/or lower control limit then this variance may trigger a machine learning service and/or a determination of a risk priority rating to send out a supplier action. In the example of length, communication may be sent to the supplier stating that the supplier is requested to shift the process mean up or down so that control limits (e.g., the lengths) will be within the set specification range. The supplier may then adjust the center of the statistical distribution to be higher or lower or the supplier may center the mean within the upper and lower control limits.

The performance attributes may not necessarily be defects of defective features but may be risk attributes or performance related attributes. Such risk measurements may happen at higher levels in the supply chain and the supplier actions to correct problems can be fed back to the lower levels.

Risk attributes can be used in the generation of risk priority ratings (e.g., risk priority numbers (RPNs)) based on the severity, detectability, occurrences, and performance attributes for defective features. These risk attributes (e.g., risk priority attributes) may be rated based in part on risk analysis. The contributions or purposes of the risk attributes can help determine what level of supplier action may be requested. The risk priority ratings obtained from the risk attributes may vary depending on each defect because the defects are specific to product designs and desired functionality. The risk priority ratings may also reflect the impact to the customer and the desired actions the customer wants to be taken in light of the defect and/or product.

The risk priority rating obtained using the risk attributes may be a broad measure of the risk to the entire supply chain including influences to delivery, cost, customer satisfaction, business continuity, market share, etc. The relationship that exists or that is defined between the risk attributes can be used to help protect the supply chain against defective features/defects which might otherwise make their way through the manufacturing process and into an end product. The relationship between the risk priority attributes can be used to generate the risk priority rating that can be used to improve and protect quality in the manufacturing process and/or supply chain. Regardless of whether the problem is visual, physical, performance, software, machine settings, etc., the desire may be to use a risk determination for a defective feature/defect to avoid these problems occurring in products that may be sent to customers.

In the example of detectability, some defective features/defects may be simply cosmetic and can be covered up or cured during assembly. Something visual or easy to detect by a customer may have less risk of significant impact on the final product, and a higher frequency of such defects may be tolerated before supplier action is requested to be taken. Such visible and easy to detect defective features/defects may receive a lower risk rating.

In other situations, the risk may be higher that a defect of a defective feature can get to a customer or even the end consumer. In this case, the risk rating or risk priority in the risk attributes may be more serious and a request to a supplier (i.e., a supplier action) for a more aggressive path for defect containment, fixes, or corrective actions may be sent. In one example, the risk priority rating may be a calculated risk priority number (RPN) using a severity rating, detection rating and occurrence value, and the RPN can be used to identify or map to a supplier action that may be immediately and electronically sent to the supplier for corrective action. The calculation of the RPN may be performed using any computable function that combines the risk attributes including: addition, multiplication, a linear function, a parabolic function, logarithmic function, or an indexing function. Alternatively, the risk priority rating may be a symbolic value that has a ranking (e.g., alphabetic ranking, an ordered list ranking or an ordinal ranking). The immediate communication of defective features/defects associated with higher risks may provide an increased amount of immediate and electronic feedback to a supplier, which may further lead to more prompt corrective actions being taken.

The types of risk attributes used may be selected using various models that use a step-by-step approach for identifying possible failures in a design, failures in a manufacturing or assembly process, or failures in a product or service. An example of a specific model that may be used for identifying risk attributes is the FMEA model (Failure Modes and Effects Analysis), which is used in industry to analyze risk evaluation.

In some embodiments, a graphical user interface may be used to present information regarding one or more of suppliers, defective features/defects, requested supplier actions, and effectiveness of the requested supplier actions. The graphical user interface may include a score card that can track dates with respect to requested supplier actions and effectiveness of those requested supplier actions. The graphical user interface may also include a supplier tree that graphically indicates one or more supplier metrics with respect to corresponding defects, effectiveness of supplier actions taken in response to identification of such defects and assignment of actions, associations between suppliers and sub-suppliers, and the like. The graphical user interface may thus enable a simplified tracking of supplier defects and defect resolutions processes, thereby improving the supply chain and quality control.

While many of the examples of defects and/or defective features provided in this description are mainly mechanical in nature, the term defect as described can equally apply to manufacturing software, manufacturing hardware, IoT manufacturing device settings and manufacturing device settings. For example, specific settings or parameters may be identified that can be adjusted or modified in a device or manufacturing machine in response to a supplier action sent to a supplier.

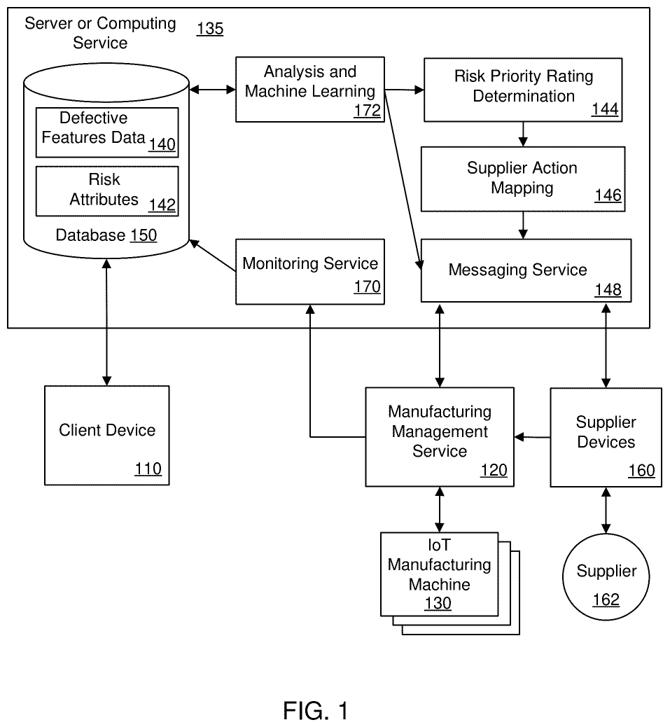

FIG. 1 is a block diagram illustrating a system for communicating a supplier action for corrective work for defective parts that are being manufactured in a manufacturing channel or problems (e.g., software or process problems) in a supply chain. Initially, one or more defective features and/or defects can be identified. This detection may be performed using hardware sensors, software sensors, software and devices during the manufacturing process and supply chain (depicted as, but not limited to, client device 110). For example, detection of a defective feature and/or defect may be handled by IoT devices, IoT manufacturing devices, supplier devices, sensor enabled devices, or even the product itself during manufacturing, final assembly or during customer use. A server in a data center or a computing service 135 in a cloud may receive or retrieve indications or data regarding a defective feature data 140 and risk attributes 142 associated with a part that is incorporated into a product. The defective feature data 140 and risk attributes 142 may be stored in a database 150.

The defective features data 140 stored in the database 150 can comprise various data of defective features and/or defects for one or more parts and may each include a defective feature number or identifier, a part name, a defect classification code, a defect description, and/or other defect information. The defect data may also describe any other aspects of the defective feature, such as a defect condition, defect sub-details, defect dimensions, a defect photo, and so forth.

The risk attributes 142 stored in the database 150 may similar comprise risk attributes for one or more parts and may include a severity rating, a detection difficulty rating, an occurrence value, and/or a performance attribute for respective defective features and defects. Other types of defect ratings, risk ratings (e.g., numeric values, ordered alpha-numeric values or risk rankings using enumerated values) may be used in the risk attributes, if desired.

An analysis and machine learning service 172 may analyze defective features data 140 and/or risk attributes 142 in the database 150 to perform or assist with various aspects of risk determination and/or messaging described herein. A risk priority rating may be determined 144 by combining the risk attributes, or the risk priority rating may be otherwise identified based, at least in part, on the risk attributes. In one embodiment, the risk priority rating may be a risk priority number (RPN) that can be a computed value. For example, the risk attributes may be numerical values that may be added, multiplied, subtracted and/or otherwise mathematically combined together (e.g., using a mathematical function). In other embodiments, the risk attributes may be symbolic rating information and the risk attributes may be combined together using a look-up table or indexing to determine an indexed version of the risk priority rating. In this example, a three-dimensional (3D) lookup table may be used but if more (or fewer) attributes are used then a higher dimensional space (or lower dimensional table) maybe used.

The risk priority rating can be a numeric value or symbolic representation that is mapped to a supplier action. The supplier action mapping 146 service may map the risk priority rating to a supplier action using a mapping function. An example mapping function may determine where a risk priority rating is classified within a plurality of risk priority rating ranges. Each of the risk priority ranges may be associated with a supplier action for correcting defective features/defects. Thus, the supplier action associated with the risk priority range within which the risk priority rating falls can be assigned to the supplier. Other types of mapping functions may also be used such as stepwise mapping functions, continuous mapping functions, custom mapping functions, etc.

An electronic message may then be automatically sent from a messaging service 148 to supplier devices 160 for use by a supplier 162, and the electronic message may include the supplier action identified in the mapping operation. In some instances, the electronic message may include the defective features data 140 associated with the supplier action or other context. In some embodiments, the electronic message can be sent immediately or in near real-time as the defect is detected or according to a schedule, etc.

The supplier action may detail a corrective action for the supplier to take for an identified defective feature and/or defect in parts provided by the supplier. For example, the electronic message may be a text message, a message sent through an application, a message sent through a RESTful API call, an instant message, an email (e.g., with HTML, embedded graphics, etc.), or any electronic message communicated as packetized data. The supplier action sent out to the supplier may be one of the following actions: i) no action, ii) supplier containment with no approval from customer, iii) a supplier containment with approval from customer, iv) a supplier containment and fix cause with input from customer needed, or v) a supplier containment, fix cause and application of a CAR/8D process with input from customer. For example, actions taken by a supplier during containment, such as fixing parts, destroying parts, fixing manufacturing machines, etc., may protect the customer by preventing non-conforming parts or material from being shipped to the customer or subsequently passed to the end user customers.

In another example, the electronic messages may be server-to-server communications between public and/or private cloud computing systems regarding physical defect features/defects or software changes. In the case of software or setting changes, the electronic messages may define a change in software parameters to correct defects of defective features or performance of a product at the end-customer or sub-component level.

Additional messages may be sent to a supplier with trending defect data in a chart or another format. For example, the trending test data may be a stacked pareto chart or a first pass yield (FPY) chart. Other types of charts illustrating trending defect data may also be used, such as bar charts, etc.

In another embodiment, a message regarding a defective feature/defect may be sent to an IoT (Internet of Things) manufacturing machine 130 or a supplier device 160 of a supplier directly or through a manufacturing management service 120 to instruct the IoT manufacturing machine 130 to perform a corrective action for the defective feature/defect IoT manufacturing machines 130 are able to collect and send data using the Internet. The corrective action may be machine implementable operations such as: suspending manufacturing, displaying a defective feature/defect message to a machine operator on a screen which is in or near the machine, modifying a physical action or other process of the manufacturing machine (e.g. modifying milling movements, part movements, conveyer belts, etc.), or modifying a defect detection process of the manufacturing machine. The IoT manufacturing machine 130 may be notified of a defective feature/defect using communications protocols that may be at least one of: Message Queue Telemetry Transport (MQTT), Constrained Application Protocol (CoAP), RESTful API protocol, or Hypertext Transfer Protocol (HTTP).

In one example, defective feature data 140 for a part may be received from an IoT (Internet of Things) manufacturing machine 130. This defective feature data may be received by a monitoring service 170 in the cloud from IoT manufacturing machines 130 as sent through the manufacturing management service 120. A message with a supplier action may be created after the IoT manufacturing machines(s) 130 have reported defective features/defects that were detected using one or more sensors in the IoT manufacturing machines 130. More specifically, the IoT manufacturing machine 130 may identify defective features/defects for parts in images or sensor data of parts (e.g., camera data, X-ray data, acoustic data, electrical data, etc.). Images or sensor data of parts may be captured as parts are moving along an assembly line, conveyer belt or other automated transport in a manufacturing area. The defective features/defects in parts may be identified based on defects identified in the images or sensor data using edge detection, pattern recognition, or artificial intelligence (e.g., neural networks or other classification methods).

The monitoring service 170 may continuously collect the defective features/defects (or defect characteristics) and related risk attributes for mechanical defects, electrical defects, or software defects. The risk attributes may include the attributes of detectability, severity, and occurrence Any device, method, or other detection scheme able to identify a defect with a performance gap for parts, manufacturing hardware or software in the supply chain may be used. Detection of a performance gap in performance attributes can also apply to non-visual defects including software, IoT manufacturing machine instructions, and machine settings.

In yet another embodiment, the supplier action that is sent to a supplier may be a message to an IoT manufacturing machine 130 with data and/or instructions to initiate or modify the detection of defective features/defects at the IoT manufacturing machine 130. The data may be the defective feature data 140 and include information defining where a defect is occurring, a defect spatial description, an image of the part, a detection search area, a pattern of the defect, and/or other defect related information. Then the IoT manufacturing machine 130 may use a camera or other detection system (e.g., signal analyzer, acoustic analysis, x-ray, etc.) to search for that defined defective feature/defect in a part. For example, pattern matching, edge detection and machine learning may be used to match part defective features/defects to graphical markings on photos or sensor data sets used to identify visible areas parts that have a problem. These graphical markings can define an inspection pattern to enable the machine to identify the defective pattern in an incoming image of a part. Further, the message to the supplier may be a message to an IoT manufacturing machine 130 that includes an image of the defective feature/defect including a marked inspection area and instructions to the IoT manufacturing machine 130 to search for the defective feature/defect in the marked inspection areas of images the IoT manufacturing machine 130 is capturing. The instructions may modify where or how the IoT manufacturing machine 130 searches for defective features/defects in images of the part captured by the IoT manufacturing machine 130 using a camera. Alternatively, simply sending the new image or new pattern to the IoT device may revise the search process for defects in images captured by the IoT manufacturing machine 130. The receipt of instructions and/or data for the IoT manufacturing machines 130 to use may create better automated inspections.

There may be other specific ways that IoT communications to IoT manufacturing machines 130 may change the way the IoT manufacturing machines 130 operate. In one example, a light or other indicator may be turned on for an IoT manufacturing machine at a certain point in the process. This light may notify a technician at the IoT manufacturing machine 130 that something is wrong with the device setup or configuration that is resulting in defective features/defects. Similarly, a text or graphical notification may appear on a screen of the IoT manufacturing machine 130 explaining that a defective feature/defect is occurring at that IoT manufacturing machine 130. In another example, a message to the IoT manufacturing machine 130 from the customer may include specific information and/or instructions (e.g., pseudo code or executable code) for correcting and detecting defective features/defects at the IoT manufacturing machines 130. In this case, the IoT manufacturing machine's behavior, movements, timing, and/or configurations may be changed due to a message received by the IoT manufacturing machine 130. Accordingly, the supplier action may sometimes be sent directly to the IoT manufacturing machines 130 to change the manufacturing process or flag a problem on the assembly line.

In some embodiments, one or more of the manufacturing management service 120, IoT manufacturing machine 130, supplier devices 160, and the supplier 162 may be part of a supplier system (not shown here).

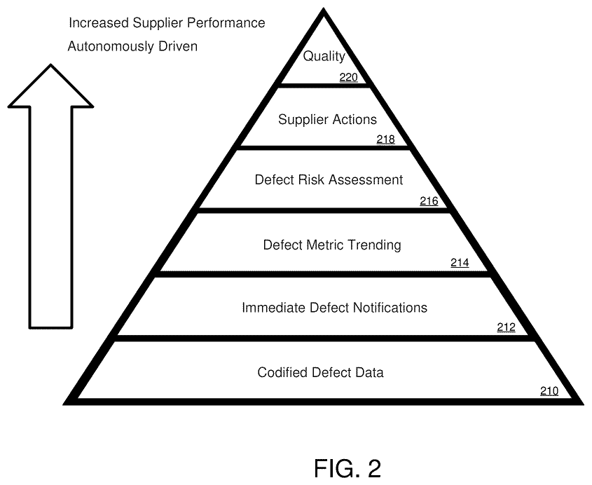

FIG. 2 is a chart illustrating an example of how the defective features data (140 in FIG. 1) can be collected and then used in order to work toward manufacturing a quality product using automated processes. Periodic codified defective feature/defect data 210 included with or generated based on the defective features data may be collected or aggregated (e.g., daily, weekly, etc.) in an automated fashion based on, for example, machine inspection of parts or assembled physical product. The classification and coding types for defective features/defects may be initially setup and may or may not be likely to change often for a particular part.

One or more defective features/defects may be identified in defect notifications 212 (e.g., an automated message or other electronic communication), along with a defect picture and/or other defect data specific to the one or more defective features/defects, to notify supplier devices and a supplier of defects in parts. Such notifications (or subsequent notifications) may include references to a storage location of the raw data and images or may directly include the raw data and images.

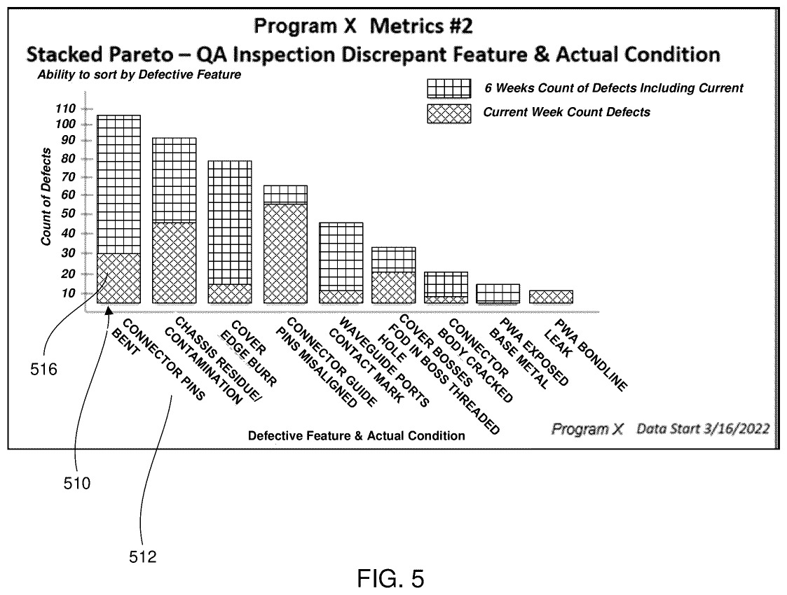

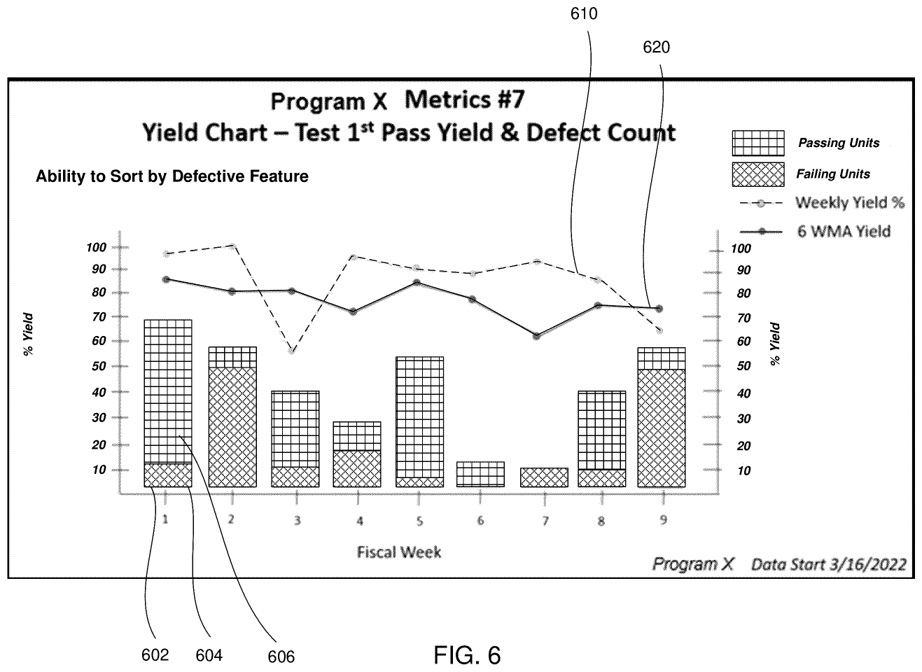

Communications (e.g., messages or notifications) may also be sent to the supplier with the defect metrics trending 214 for one or more defective features/defects. A communication for the defect metrics trending for all of the defective features/defects of the product and their impacts may be sent to the supplier on a periodic basis (e.g., daily, weekly, monthly, etc.). The defect metrics trending may include bar charts with a multi-week count of defects and current defects (See FIG. 5) and a yield chart showing first pass yields and rework yields (sec FIG. 6).

A defect risk assessment may also be computed 216 or determined. This defect risk assessment may result in a risk priority rating that may be a value or index key that results in a mapping to a supplier action 218. The defect risk assessment may be specific to each defective feature/defect reported in the defect notifications, such that a single defective feature may have multiple defect risk assessments if the single defective feature comprises multiple defects. The notification sent to a supplier may also list the supplier action(s) that is assigned to a supplier device or IoT manufacturing machine of a supplier. The supplier action(s) may include any one of the actions of: containing the defect, fixing the defect, applying a quality control process to find the root cause of the defect or other desired quality control actions. The supplier action(s) may be assigned per defect or per defective feature/defect.

By providing the supplier action(s) to the supplier based on identified defects of defective features, the supplier can correct issues resulting in the defective features/defects, thereby reducing future defective features/defects. Thus, correcting the defective features/defects leads to higher product quality 220, a more effective manufacturing process, and better final manufactured products.

Supply chain decisions are generally focused on quality, delivery and cost. Cost in monetary terms or currency values tends to be apparent. Delivery quantity and time deadline commitments are also numeric. Providing quality can be the hard part of the manufacturing process. This technology enables a customer to obtain quantitative defect figures that are directed toward the quality of the process and product. The present technology can also assist with the quality, defect identification and communication processes by automating areas such as: defective feature/defect data collection and characterization, electronic notifications to suppliers, defect trend generation and notification, defect data correction by suppliers, automated metric notifications, calculations, supplier action levels, supplier actions, supplier action notifications, and/or tracking feedback.

The present technology may result in immediate reactions in the supply chain, so there is more compliant product on time and at the originally approved shipment date. The product quality, delivery, and customer satisfaction can be improved through these automated processes.

Automating the transfer of quality control information and providing information and instructions to IoT devices or supplier devices may have valuable results. One such result is increased efficiency and effectiveness of the quality resources (data pipelines, databases, suppliers, manufacturing devices, etc.) due to automation.

Another benefit of automation in the quality process is an increased scope of coverage for quality performance analysis for suppliers. Specifically, more aspects of the process may receive feedback over time. By increasing efficiency of quality control processes based on such automation, quality inspections and feedback can be provided for more areas of the product manufacturing process.

Another valuable aspect of automating quality control feedback is the ability to provide timely notifications to suppliers regarding defects observed. For example, prompt defective feature/defect feedback in real-time or near real-time with detection of the defective features/defects may result in early containment of similar defective features/defects and correction or curing of corresponding sources of the defective features/defects, which can lead to a reduction of defective parts and defective final products received by a customer. Messages sent directly to suppliers upon finding defective features/defects also may allow proactive supplier investigation of defect trends before the defects influence part deliveries. Ultimately, the goal is a reduction in customer returns, scrapped products, and test failures based on addressing computed product risks or computed defect risk assessments.

These processes described for automation are applicable for any supplier defect features and defects that may be identified. An FMEA style approach may be applied which counts defect occurrences for the defective features/defects and combines these with the severity rank of each defect type and the detectability rank to determine a risk priority rating. The risk priority rating (e.g., an RPN) may then be used to determine a supplier action level the further corresponds to a supplier action (e.g., containment, fix, CAR/8D) that may be assigned to the supplier to perform.

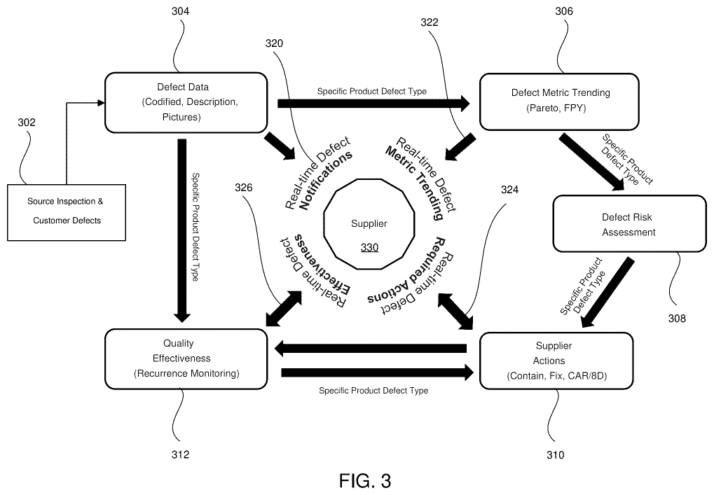

FIG. 3 is a block diagram illustrating an automated flow for assigning supplier actions to correct defective features/defects. A quality assessment and engineering evaluation may include inspection (for example, by automated inspection machines or devices) of parts or assembled product and identification of defective features and/or defects, as in block 302. This work may be described as a source inspection.

Such a source inspection may provide defective features data (such as the defective features data 140) that may include one or more of defect codifications, defect descriptions, risk attributes, detection assessment, and pictures or other raw data representing the detected defect, and so forth as part of a data set shown in block 304. This data set may be generated based on defined enumerated types and knowledge of the subject product and the desired product quality, such as defined standard defect codification codes and/or values.

As shown in FIG. 3, based on this defect data of block 304, real-time (or near-real time, scheduled, etc.) defect notifications 320 may be generated and sent to supplier devices and IoT manufacturing machines of a supplier 330. Such notifications may enable the supplier devices and/or IoT manufacturing machines to identify that the supplier 330 is providing a customer with parts that include defective features/defects.

Aspects of the defect data of block 304 may be employed to determine defect metric trending at block 306. As such, defect metric trending reports may be generated and sent to the supplier 330 at periodic intervals at 322. The defect metric trending reports may be in the form of stacked pareto charts, FPY (first pass yield) charts or other graphical charts. The defect metric trending reports may be generated based on specific defective features/defects, product defect types, etc., and the defect data may be the basis for different reports.

The risk priority rating (e.g., a risk priority number RPN) can be calculated for each defective feature/defect and the risk priority rating may be converted into a supplier action to include in the defect notifications. Further, data regarding the defective features/defects and the associated defect categorization can be included in automated defect notifications that are sent to suppliers 330.

Data regarding the determined defect metric trending from block 306 may be further used to determine a defect risk assessment at block 308. More specifically, the risk that is represented by certain defective features and/or defects may be determined and/or defined based on, for example, the defect metric trending generated based on defective feature data collected from sensors, manufacturing devices and supplier devices. For example, the risk attributes collected for defective features and/or defects may be part of the defect data of block 304. One example of this is the severity rank by defective feature/defect. For example, the severity rank may be a value between 1 to 10 or 1 to 100 corresponding to a severity of the detected defect. Alternatively, the severity rank may be a coded value or enumerated type, such as high, medium and low. Other examples of codified risk are a detectability rank and an occurrence value by defective feature/defect. As introduced above, a risk priority rating may be calculated or determined from the severity rank, detection risk and occurrence value for defects. More specifically, the risk assessment at block 308 may use a calculation, a look-up table (LUT) and/or a mapping function, as described earlier, to generate the risk priority rating. A plurality of risk priority rating ranges may be provided for the various types of defective features/defects.

The output of the defect risk assessment at block 308 (e.g., certain defect and/or risk priority rating data) may then be used to identify supplier actions to correct part defective features/defects, as in block 310. The supplier actions may request: defect containment, defect fixes or applying a defect correction process, such as CAR/8D. More specifically, a supplier action level and supplier action determination may be made based on the risk priority number range within which the risk priority rating falls into, at block 310. The supplier actions may be sent to the supplier 330 at 324, IoT manufacturing machines or other manufacturing devices to enable correction of part defective features/defects or other problems to take place.

Block 312 shows determination of an effectiveness of the actions of the supplier 330 in response to the various communications or notifications 320, 322, and/or 324 via recurrence monitoring or the like. For example, where the supplier 330 provides increased quality output and improved product effectiveness, then the supplier 330 has been effective in curing the defects and/or defective features indicated by the defect data of block 304. However, where the recurrence monitoring of the defective features/defects (which may be performed to determine whether previously detected and notified defective features/defects to not reappear in the manufacturing process) determines that the notified defective features and/or defects have not been cured by the supplier 330, the supplier 330 has been ineffective at curing the defects and/or defective features indicated by the defect data of block 304. Communications at 326 can be used to inform the supplier 330 whether it has been effective curing the defective features and/or defects based on communications of 320, 322, and/or 324

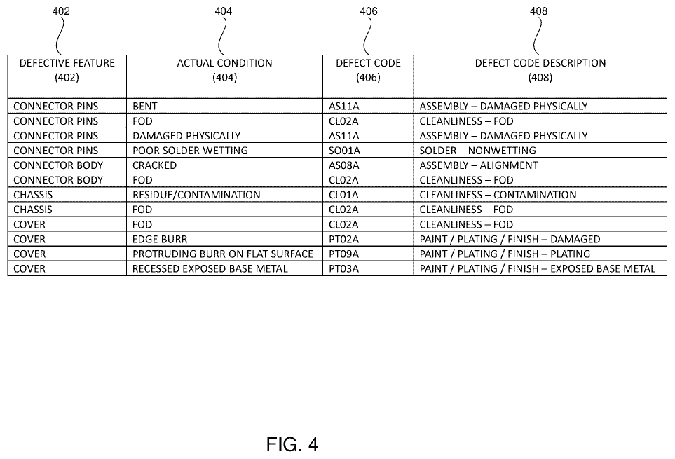

FIG. 4 illustrates an example portion of a table for codified defective feature data. The table shown includes columns and rows representing fields of data included for a part supplied by a supplier. The columns may include a defective feature column 402 (i.e., indicating a discrepant feature, characteristic, performance attribute, or component) with a name detailing: a part name, part aspect, hardware, or software that has a defect in a supply chain. Alternatively, or additionally, the risk attributes may include another identifier type to identify the part name/aspect. An actual condition column 404 may include fields that describe the condition, or defect, of a corresponding defective feature. For example, the actual condition column for a row may describe an edge burr or poor soldering as the defect for the defective feature identified in the defective feature column 402 for the respective row. A defect code column 406 may define a defect code value assigned to a defective feature and/or defect. A defect code description column 408 may define a description associated with the identified defective feature and/or defect of the corresponding row. The table may optionally include a code referring to a re-work plan (not shown) and standard re-work title describing the work to be done to fix the defect. For example, a plan may be set for straightening bent connector pins or trimming an edge burr.

FIG. 5 illustrates an example stacked pareto chart reporting defect metric trends as described herein. In particular, the chart may illustrate defective feature and/or defect occurrence reporting and trends for each codified defective feature/defect. A bar 516 in the chart may illustrate a total count of defects 510 for defective features and their actual conditions 512. The defective features and their actual conditions 512 may correspond to the defective feature and actual condition columns 402/404 respectively of FIG. 4. The top portion of the bar 516 may represent a defect count for an aggregate period of time. For example, a 6 week count of defects including the current week's defects may be depicted in the top portion of the bar 516. The bottom portion of the bar 516 may represent the defect count for a period of time different from the aggregate period of time of the top portion, such as a current week's defect count. This chart allows the current week's count of defects to be clearly compared to the count of defects for the aggregate period of time. For example, the chart may illustrate that the number of bent connector pins of the current week (i.e., approximately 30) is higher than the recent average weekly trend of bent pins over last 6 weeks (i.e., approximately 105 bent pins over six weeks for an average of 17.5 pins per week). This chart may also enable comparisons between the count of defects for the multiple displayed defective features and their actual conditions 512.

FIG. 6 illustrates a chart depicting a first pass test failure defect count and yield trending chart for a codified defective feature/defect type. Each bar 602 in the chart represents a percentage of passing and failing units for a part in a particular fiscal week. A first sub-portion 604 of the bar 602 represents the percentage of failing units or parts that may be corrected or discarded. A second sub-portion 606 of the bar 602 represents the percentage of passing units or parts that may be immediately used in products that ship to customers. The chart further illustrates a first weekly yield line 610 that illustrates a weekly yield percentage moving average. A second line 620 is illustrated the represents the weighted moving average (WMA) of the weekly yield percentage.

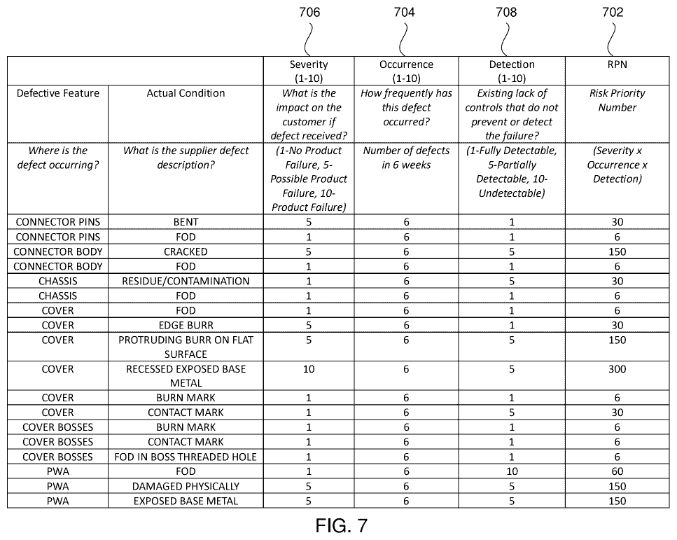

FIG. 7 illustrates the risk attributes of severity, occurrence and detectability which can be used to calculate a risk priority rating (e.g., a risk priority number (RPN) shown in the RPN column 702) as they relate to particular defective features and defects (corresponding to the defective features and actual conditions of columns 402/404 of FIG. 4). The count, or number of occurrences, of defects may be stored in the occurrence column 704 for each defective feature/defect pair. The count of defects may refer to how frequently the defect of the defective feature of the same row occurred (i.e., how many defects occurred within a particular period). The occurrence value in the occurrence column 704 may be used to increase the risk priority rating and may also be incorporated into the defect metric trending that is reported. The severity column 706 may define a severity value for a particular defective feature/defect of the row, where the severity value may be ranked on a numerical scale. The ranking on the numerical scale may be predefined. The severity value depicted in the severity column 706 may be related to broad supply chain aspects such as: impact on product performance, delivery timing, cost, impact on the end customer, impact on suppliers higher in the supply chain, etc. The detectability column 708 may define a value that refers to the ability to detect the defect of the defective feature (e.g., how easily detectable is the defective feature/defect pair), for example, by a main supplier, upstream supplier, a customer, an end user customer, or another party associated with the manufacturing process. The RPN column 702 may define the RPN for each defective feature/defect identified in the different rows of the table, where the RPN value for each defective feature/defect is calculated based on the corresponding values in the severity column 706, the occurrence column 704, and the detectability column 708.

The risk attributes may be stored in a database (see 150 of FIG. 1) which may be a relational database, a NoSQL database or another type of data store. One or more of the severity values, occurrence values, and detection values may be determined by a supplier device, an IoT manufacturing device, a sensor device or another type of manufacturing device and may be ranked on a numerical scale and stored in the database.

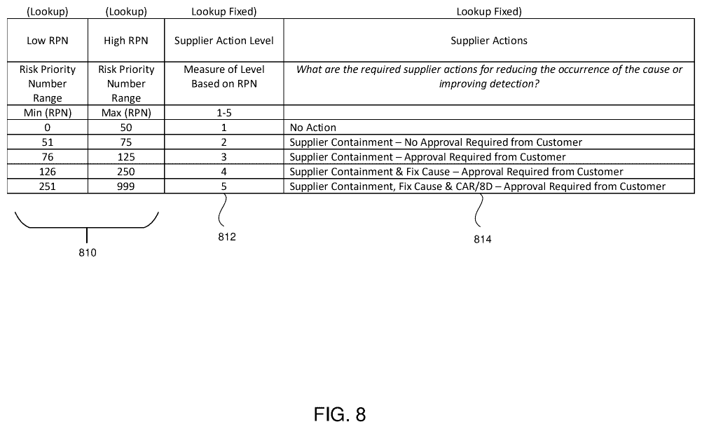

The risk priority rating (e.g., RPN) determined from the risk attributes may be used to map defective features/defects to respective supplier action level defined in supplier action level 812, as illustrated in FIG. 8. The mapping table in FIG. 8 illustrates that risk priority rating number ranges 810 are created for each supplier action. The range within which the risk priority rating (e.g., RPN) falls may determine the supplier action 814 that is assigned to a supplier for the defective feature/defect having the assigned risk priority rating (as in the RPN column 702 of FIG. 7).

The risk priority rating may represent the combination of the severity of a defect, the occurrence count, and how easy or difficult the defect is to detect. The defects may be categorized based on, for example, where and/or what the defect is. Once the severity and detectability attributes have been set, then the risk attribute that may change most quickly is the occurrence attribute of the defect. As the occurrence attribute counts and risk priority ratings increase, more aggressive supplier actions can be requested by the supplier. The severity and detection attributes may change if the severity or detectability changes for a defective feature/defect but these attributes are more likely to change slowly over time as compared to the occurrence attribute. Each supplier action level may have a numeric value (e.g., 1-5, 1-10, or 1-100), an alpha-numeric value (e.g., A-Z), an ordinal value (e.g., high, medium, low, etc.) or another rating symbol that is associated with the risk priority rating.

As discussed, FIG. 8 illustrates an example table for mapping a risk priority rating (that is a risk priority number (RPN)) to a supplier action 814. The risk priority rating number ranges 810 are set to map the risk priority number to a supplier action 814 and supplier action level 812. While the present example in FIG. 8 shows 5 possible actions, there may be any number of supplier actions. In general, the higher the occurrences of a defect, the more extensive corrective actions may be requested of the supplier. The lowest level of action may be no action, but then if the occurrences of defects increases for a defective feature then the supplier action level 812 may increase to 2 and formal containment by the supplier may begin. An increased supplier action level of 3 may also include formal containment and a report (e.g., a defective feature report) back to one or more customers. Further, at containment level 4, the cause of the defect is requested to be fixed. Finally, at level 5, a rigorous quality control process is requested to be applied.

In one embodiment, the risk priority rating may be updated each time an occurrence of a defect feature/defect is received. Alternatively, the risk priority rating may be updated on time period basis (e.g., every day, every week, etc.)

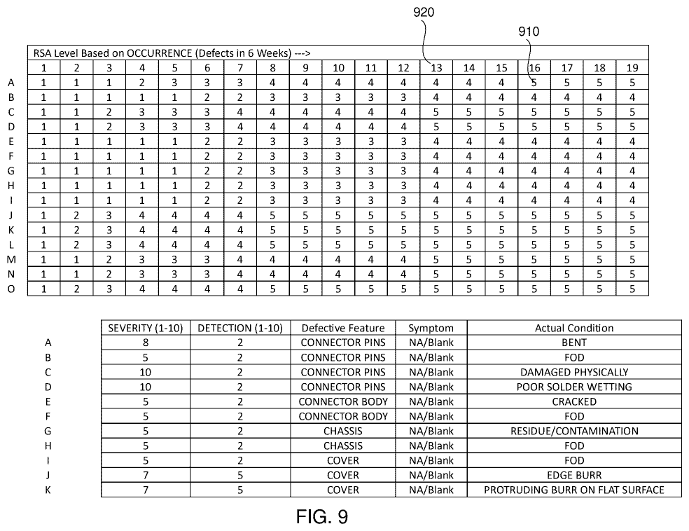

FIG. 9 illustrates an example of progressive supplier action levels based on a count of defects in a 6 week period. More specifically, FIG. 9 illustrates how different combinations of defective features/defects may have different progressive supplier action levels. The supplier action levels 910 can be displayed in a graphical chart as compared to a number of defect occurrences for each defective feature/defect over a plurality of defined time periods 920 (e.g., weeks). The more severe the defective feature/defect or the more difficult it is for a customer to detect a defective feature/defect, the faster the supplier action levels may escalate through the levels of supplier action even when there are a lower number of defect occurrences. When higher levels are set in the severity and/or detection columns 706 and 708, respectively, of FIG. 7, these higher levels will advance the supplier action levels faster when respective defective features/defect occurrences are detected. The ranges may be fine-tuned to move the supplier action levels at a desired rate depending on the type of product and the customers' defect tolerances. The lettering to the side of the two tables in FIG. 9 indicates the rows from the bottom table align with the rows of the top table such that the row A of the top table is a continuation of the row A of the bottom table.

It follows that if the defective feature/defect is less critical (i.e., has a lower severity value) and/or more detectable (i.e., has a lower detectability value), then the defective feature/defect may progress through the supplier action levels more slowly. For example, foreign object debris or chassis residue/contamination (row G of the bottom table), that can be easily removed from the product, may progress through the supplier action levels slower (as seen by row G of the top table). In another example, the defect may be a recessed exposed base metal of a cover (row L of the bottom table), and the defect may be difficult to detect and may affect the final product's performance. Because there is a significant risk the defect could ship to customer, then much more aggressive supplier action may be desired (as seen by the quicker progression of row L through the supplier action levels of the top table). In this example case, the supplier may be asked to take action sooner with less occurrences of the defect.

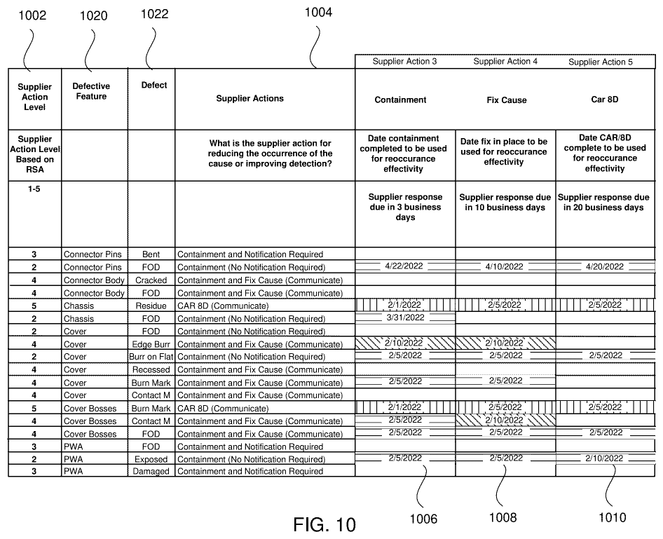

FIG. 10 illustrates an example of a quality effectiveness scorecard and system coding. A column may be provided for the supplier action level 1002 and associated supplier action 1004 for each defective feature/defect. The score card may also illustrate supplier action dates for specific defective features/defects and corresponding supplier actions.

The score card can summarize the defective features/defects (e.g., discrepant features/actual conditions) and corresponding supplier actions that are assigned to the supplier. More specifically, each row of the score card may correspond to a different defective feature 1020 and defect 1022. Initially, for each defective feature/defect with a supplier action, a response date is automatically set by the customer by which the supplier should provide a date for completing the supplier action. The supplier can then provide an effectivity date for taking the requested supplier action, where the effectivity date for taking supplier action replaces the response date in the corresponding column. For example, at supplier action level 2, no official response is required to the customer, but the supplier should be taking action to contain the defective feature/defect by an effectivity date offered by the supplier. At a higher supplier action level, an effectivity date may be set for completing the supplier action and the supplier is asked to respond by that effectivity date for completing the supplier action. More specifically, a containment action may have a response date for the supplier to provide an effectivity date for completing the supplier action. Then the supplier may provide a containment effectivity date 1006, after which the defect should not be seen past this certain date. Effectivity dates 1008, 1010 may also be provided for fixing the cause or applying a quality control process (e.g., CAR 8D) and customer approval will be requested for corresponding supplier action levels.

Dates that are highlighted in yellow, as depicted by diagonal pattern lines in FIG. 10, may indicate that supplier action is needed (containment, fix, CAR/8D), but supplier information regarding completion of a fix has not been submitted. The dates that are green in color, as depicted by horizontal pattern lines in FIG. 10, may indicate that a supplier effectivity date has been received or an action that has been completed. For example, the green color may be set when the supplier has indicated the supplier has completed a supplier action (e.g., containment, fix, CAR/8D) on the effective date indicated.

In one embodiment, the effectiveness of a supplier's actions in correcting the defective features/defects may be tracked. For example, the supplier may notify the customer that the defective feature/defect will be fixed by a certain date. However, if a sensor device or manufacturing device that reports to a monitoring service sends another occurrence of the defective feature/defect prior to the fix date, then this occurrence (e.g., from a sensor device or IoT manufacturing device) may indicate the problem has not yet been fixed. The fact that that defective feature/defect or problem has not been fixed as expected can be indicated by flagging the supplier action as ineffective in an message prior to an action completion date. This may also be flagged in a graphical user interface for the customer, as in FIG. 10, or new defect occurrence may be flagged in additional electronic communications to the supplier.

The dates that are highlighted with a red color, as depicted by vertical lines in FIG. 10, indicate that an action taken by the supplier has been ineffective. For example, the supplier action may be ineffective due to a defect occurring prior to the action completion date. In this case, a re-submission of an additional revised supplier action and an updated date may be requested from the supplier.

Ineffective actions that are taken by the supplier may set as a top priority because the defective feature/defective has been identified but was not fixed properly. Where only one further defect results in flagging the defective features as a top priority, this means there is no tolerance for a further defect. Effectively, this flagging of an ineffective date may effectively increase the risk priority rating of the defective feature/defect to the highest priority. Even after the ineffective fix has been corrected the monitoring service may continue to detect whether this correction was effective in perpetuity. Alternatively, there may be a reset trigger for the defective feature/defect that resets after a time threshold (e.g., one year) has been reached and defects received for the same defective feature after that time threshold may be considered new defective features/defects.

When the supplier responds with the updated date for a containment, fix, or CAR/8D then the date for that supplier action may turn green.
Table 1
Yellow=Supplier action needed or required
Green=Supplier took action
Red=Supplier action was ineffective
   While certain color schemes are described here as in Table 1, any colors may be used as long the color meanings for the dates are known to all parties and are distinguishable from one another.

The customers and suppliers may have weekly supplier reviews to discuss the scorecard. Such meetings may discuss supplier actions that are in progress, need to be started or have been completed. In particular, the meetings may focus on supplier actions that have failed and the complete date needs to be reset. In an automated system, if a supplier is doing poorly, then the requested quantity of parts may be reduced and this may be a big incentive to increase part quality.

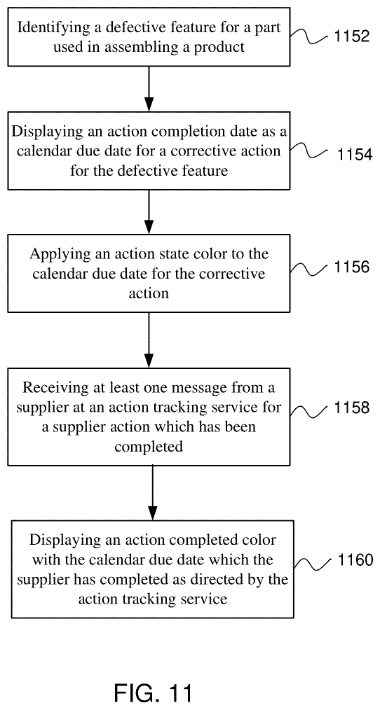

FIG. 11 is an example of a method for displaying supplier actions in response to a defective feature/defect notification using a graphical user interface, such as FIG. 10. The method may include identifying a defective feature/defect for a part used in assembling a product, as in block 1152. An action completion date may be displayed as a calendar due date for a supplier action to correct the defective feature/defect, as in block 1154. The supplier action may be: containment of the defective feature/defect, fixing of a cause of a defective feature/defect or applying a manufacturing quality control process. The calendar due date may be displayed with a supplier action level and a supplier action description for a defective feature/defect. The calendar due date may be initially determined or calculated based on a current date plus a number of days allowed for taking the supplier action.

An action state color may be applied to the calendar due date for the supplier action, as in block 1156. The action state color for the state of “supplier action needed” may be yellow and the “supplier action completed” color may be green.

A message may be received from a supplier at a monitoring service for a supplier action which has been completed, as in block 1158. Alternatively, a message may be received at the monitoring service regarding an additional part defective feature/defect occurring prior to the action completion date. As a result, an action ineffective color (e.g., red or orange) may be applied to the calendar due date for the supplier action.

A further operation may be displaying an action completed color with the calendar due date which the supplier has completed as directed by the monitoring service, as in block 1160. The action completed color may be green, blue or another “calm” color.

In one embodiment, the software may determine when the calendar due date has passed for receiving an indication that the supplier action has been completed for the defective feature/defect, using the monitoring service. At that point, an action not submitted color may be applied to the calendar due date for the supplier action. Specifically, an example of the action not submitted color is red but another color or highlight feature (e.g., flashing, inverse text, etc.) may be used.

In some embodiments, the method for displaying supplier response to a defective part notification using a graphical user interface comprises different steps that shown in FIG. 11, such as identifying defective feature data associated with a defect in a part used in assembling a product, displaying an action completion date as a calendar due date for a supplier action for correcting the defect, applying an action state color to the calendar due date for the supplier action for display with the calendar due date, receiving a first message from a supplier system at a monitoring service, the first message indicating that the supplier action has been completed, and updating the action state color displayed with the calendar due date to an action completed color based on the indication that the supplier system completed the supplier action as directed by the monitoring service.

In some embodiments, the supplier action may be at least one of: containment of the defect, fixing of a cause of the defect or applying a manufacturing quality control process. Additionally, the method may further comprise identifying, at the monitoring service, additional defective feature data indicating that another defect occurred after the action completion date and updating the action state color displayed with the calendar due date to an action ineffective color based on the identified additional defective feature data as directed by the monitoring service.

Such a method may further comprise determining when the calendar due date has passed without receiving the first message, using the monitoring service and updating the action state color displayed with the calendar due date to an action not submitted color based on not receiving the first message before the calendar due date passed. The method may further comprise displaying, along with the calendar due date, a supplier action level, a supplier action description, and a subset of the defective feature data associated with the part defect. The calendar due date may be initially determined based on a current date plus a number of days allowed for implementing the supplier action.

In another embodiment, a method for managing a plurality of suppliers that supply parts for a product using a graphical user interface comprises identifying a plurality of defective features of the product for which suppliers have been assigned supplier actions, determining a supplier maturity metric for a supplier of the plurality of suppliers using risk priority ratings for a subset of the plurality of defective features associated with the supplier, displaying a tree graph, wherein a node of the tree graph represents the supplier of one of the parts for the product and an edge of the tree graph represents a product part movement between tiers or levels of suppliers, displaying the supplier maturity metric and a graphical user interface control associated with the supplier, and receiving an activation of the graphical user interface control to initiate a remedial action associated with the supplier.

The graphical user interface control can initiate the remedial action that is halting of further shipments of a part from a supplier. The graphical user interface control can initiate the remedial action that is sending a message to a supplier to stop shipments. The graphical user interface control can initiate the remedial action that is stopping of further manufacturing of a part.

In some embodiments, the method may further comprise sending a message to an IoT manufacturing machine to stop manufacturing a part upon activation of the graphical user interface control. The graphical user interface control can initiate the remedial action that is presenting an alternative supplier that can be selected to provide parts in place of a supplier. The method may further comprise receiving a selection of the alternative supplier for a part, sending a first notification to the alternative supplier to increase part production, and sending a second notification to the supplier to decrease part production.

Though the steps and aspects of the methods above may not be shown explicitly in FIG. 11, they may be similarly performed or enabled by the technologies described herein.

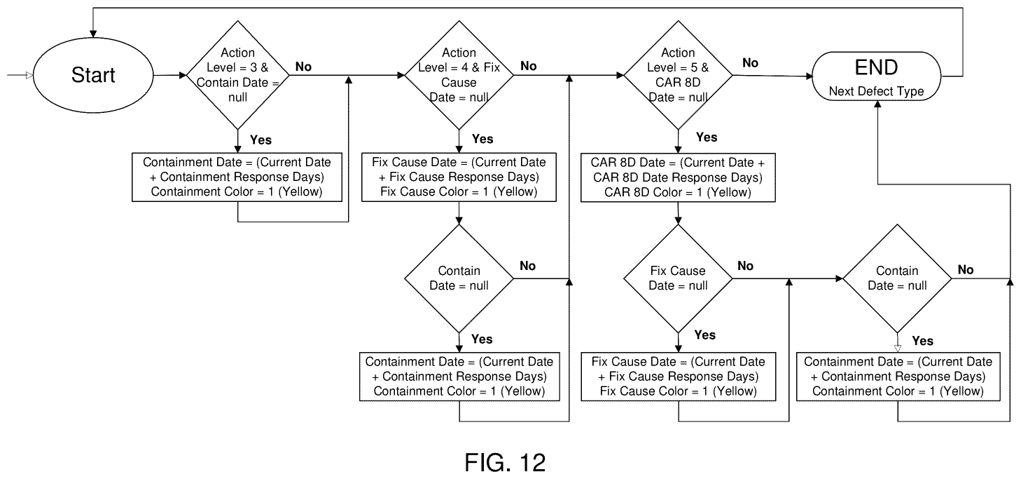

FIG. 12 is a flow chart that illustrates an example of the assignment of supplier action dates, for example, for the score card of FIG. 10, when no date already exists. For example, a date assigned to a supplier action for fixing a defective feature/defect may be the current date plus the number of days expected to perform a containment, fix or quality control process. The event that starts the process may be sending of the supplier action, supplier acknowledgement of the supplier action, the creation of the defective feature/defect, or an associated event that is part of correcting a defective feature/defect.

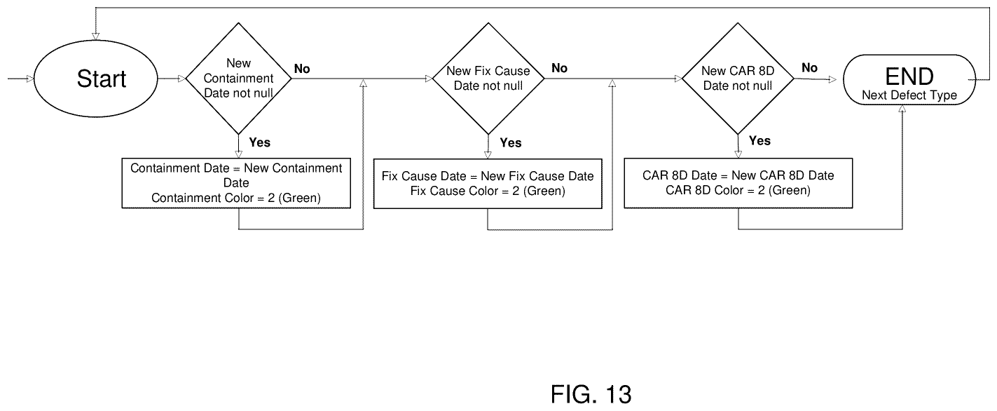

FIG. 13 illustrates the changing of dates with new supplied dates from a supplier, for example, for the score card of FIG. 10, when a date already exists. For example, a supplier may report that a containment, fix or quality control process has a successful date that the remediation was completed. In this example, the color highlighting of the date may automatically be set to green when a message has been received from a supplier or supplier device that the remediation was completed. The remediation may be received from a computing device of the supplier that has sensors (e.g., visible cameras, infrared, sonic detection, x-ray, etc.) and software to verify that remediation was completed. For example, an IoT manufacturing machine may report back to a monitoring service.

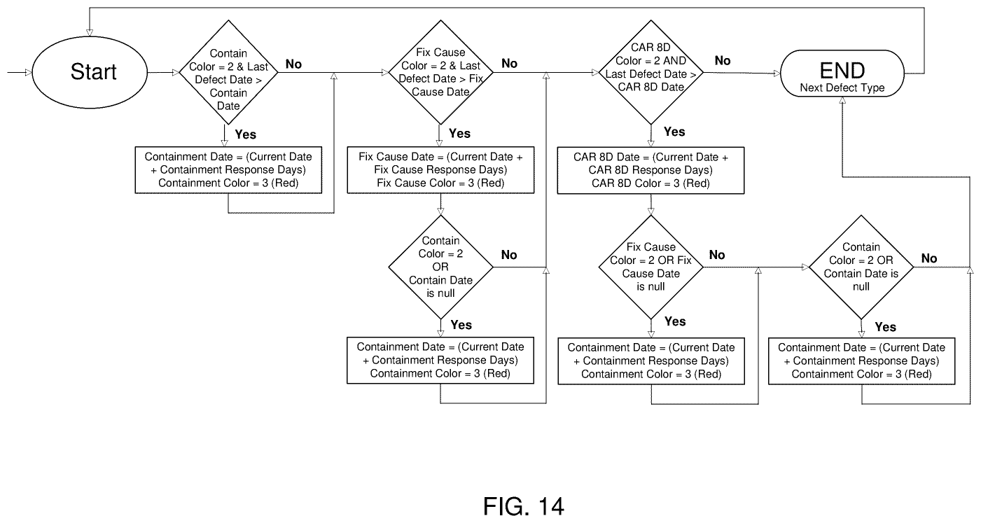

FIG. 14 is a flowchart illustrating changing dates for supplier actions that are ineffective, for example, for the score card of FIG. 10, where dates already exist. For example, if a new occurrence of a defective feature/defect is received before the defective feature/defect has been contained, fixed or had a quality control process completed, then the highlighting of the date may be set to red. The new defective feature/defect occurrence may be detected by a device with sensors and software to detect defects or from an electronic message from an inspection by an electronic device in the supply chain owned by: a supplier higher in the supply chain, the main supplier, the customer or an end user customer. At this point the system and customer, may wait for the supplier to provide a new date for performing the supplier action.

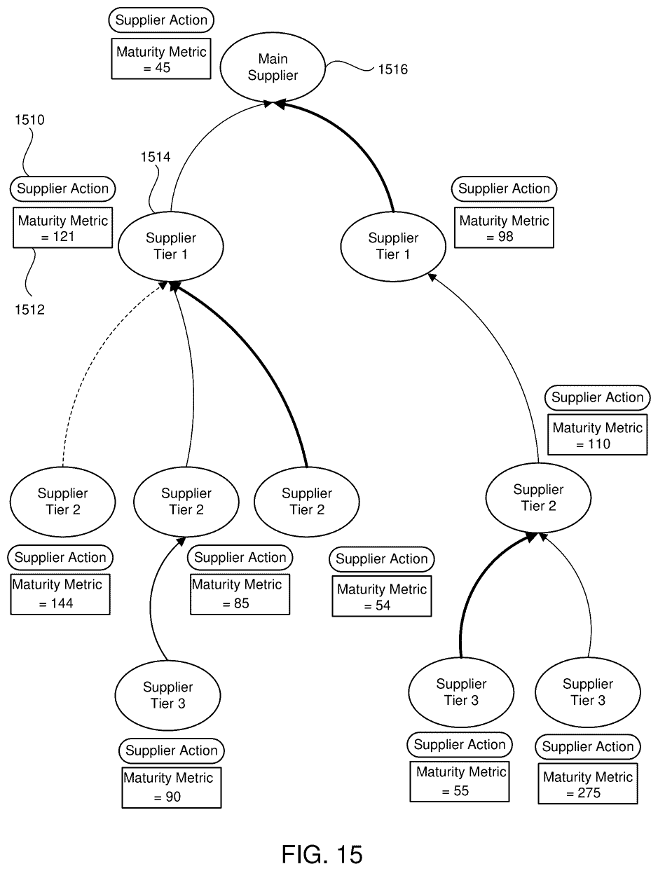

FIG. 15 illustrates an example graphical user interface and process for managing a plurality of suppliers that supply parts for an assembled product. A plurality of defective features/defects for the product can be identified for which suppliers have been assigned supplier actions to correct defective features/defects. A supplier maturity metric may be determined for an individual supplier using the plurality of the defective features/defects and risk priority ratings for the plurality of defective features/defects associated with the supplier. For example, the risk priority ratings for the defective features/defects may be summed, multiplied, indexed or otherwise combined using a function to form the supplier maturity metric. Alternatively, other manufacturing information may be combined into a single value of performance based on the supplier's current status (such as whether the supplier is behind, responsive, having a large number of defect occurrences, etc.) and this combined rating may be used as the supplier maturity metric. Further, the supplier maturity metric may optionally be influenced by the sub-suppliers' supplier maturity metrics because the supplier may have the responsibility to manage the sub-suppliers and make the best quality product from the parts received from sub-suppliers. Generating a supplier maturity metric may enable part sourcing selections to occur based on issues other than cost and delivery. Accordingly, the risk priority ratings for the defective features/defects may be combined for the supplier to provide a numeric value that represents supplier maturity metric. A higher value may represent more problems and less maturity (or vice-versa).

The suppliers for product parts may be displayed on a tree graph as depicted in FIG. 15. A node of the tree graph may represent the supplier 1514 of the product part and an edge of the tree graph may represent parts moving between suppliers. The root of the tree may represent the assembly of the product or a main supplier 1516. Multiple tiers of suppliers can be located at different levels depending on where the suppliers' parts fit into the assembly process. A sub-tier supplier can be connected a supplier a level above them. Some of supply paths may be moving very well (e.g., like a highway and illustrated by a thicker solid line), while some supply paths are moving slowly (e.g., like a dirt road and illustrated as a thin solid line) and others have issues and/or are stopped (e.g., dashed lines).

The supplier maturity metric 1512 may be displayed as being associated with a supplier 1514 in the tree graph, and a graphical user interface control 1510 may be associated with the supplier. A tree graph may be used because the parts are shipped to a main supplier that is an assembler (i.e., puts the parts together) and the main supplier sources parts from other suppliers. By tracking defective feature(s)/defect(s) and tracking the sub-suppliers' performances in real time, the graphical user interface can display when a supplier is having problems, as the problems are actually occurring. Then these problems may be addressed using the graphical user interface. The supplier maturity metric may apply to each supplier 1514 as illustrated. Alternatively, the supplier maturity metric may be aggregated for a specific group of suppliers or a tier of suppliers in the tree.

The system may receive an activation of the graphical user interface control 1510 to perform a supply chain action associated with the supplier. A supply chain action may be an action taken with respect to the supplier or the movement of parts. The graphical user interface (GUI) control 1510 may be a button, a radio button, a drop down window, a pop-up window, a multi-select control or other GUI controls. For example, the GUI control 1510 can initiate the action of automatically halting of further shipments of a part from one of the plurality of suppliers or sending a message to a supplier to stop shipments. The GUI control 1510 may always be present with the nodes of the tree or the GUI control 1510 may appear when a supplier has a poor maturity metric.

In another example, the GUI control 1510 can initiate the supply chain action that is stopping of further manufacturing of a part. For example, an email, text message, instant message, or other message communicated as packetized data may be sent to a responsible party to stop manufacturing. Similarly, a message can be sent to an IoT manufacturing machine to stop manufacturing a part upon activation of the GUI control 1510.

The GUI control 1510 or a button can also be configured to present an alternative supplier that can be selected to provide parts in place of or as a supplement to the first supplier that has a worse maturity metric. The alternative supplier may also be selected using other GUI controls 1510 like directly selecting a node representing the supplier. Once the alternative supplier is selected for a part, then a first notification can be sent to the alternative supplier to increase part production. Next, a second notification can be sent to the supplier to decrease part production. Accordingly, this type of a tree interface may authorize shipments of parts, stop shipments of parts, initiate or stop sampling or inspections, or initiate a defined level of machine inspection (e.g. start 75% part inspection) directly through the tree interface.

This graphical user interface can be used to send messages to sub-contract manufactures and their key sub-suppliers automatically. There may be multiple sources of supply in assembling the physical product and this interface allows a manager to approve shipment from one source of supply over another based on the issues that a supplier may be having at that point in time. The entire supply chain for a product may be managed based on the final customer's results and a desire to improve yield at higher levels in the supply chain. This may also result in greater overall throughput for the supply chain.

The graphical tree or another directed graph may be used to represent different suppliers' and process maturity. This chart can present the current data that when compiled together represents supplier maturity metrics for each supplier. Thus, a manager can look at a supplier maturity metric and see if the supplier maturity metric is improving, stabilizing or declining. Furthermore, a customer (or a downstream supplier) can quantify each of the supply flows from suppliers based on their capability and performance. A customer can also see where the defective features/defects in the supply chain are located in the tree. If the yield for a node or branch goes to zero, the customer can also see that change in real time. As a result, the customer can mark branches that are having problems when the problem is actually happening and not later. This allows a customer to view those supplier pathways which are most capable in real time. In some embodiments, a supplier's (or sub-supplier's) maturity metric may be an aggregate of its sub-supplier's maturity metrics (if any) as well as its own maturity metric.

In some embodiments, the indicates for each supplier may be integrated with status of that supplier from the score card of FIG. 10. For example, when the supplier has one or more defective features/defects that have requested supplier actions, one or more colors indicated in the score card can be displayed on an indicator in the graphical tree of the graphical user interface of FIG. 15. As such, the graphical user interface can convey information about what may cause the supplier's maturity metric. In some embodiments, the score card may be accessible from the graphical user interface (for example, by selecting a particular supplier in the tree graph) may display the score card of FIG. 10 to enable a determination of what may be causing the supplier's maturity metric.

In some embodiments, the maturity metric, or other defective feature data described herein, may be used to dynamically adjust sourcing of parts. For example, as the defective feature data indicates that defects are trending poorly for a supplier, part quantities ordered from that supplier may automatically be reduced. Similarly, suppliers with positive maturity metrics may have part orders increased. As such, the automated defective feature and defect detection and corresponding technologies described herein may dynamically improve sourcing of parts as appropriate.

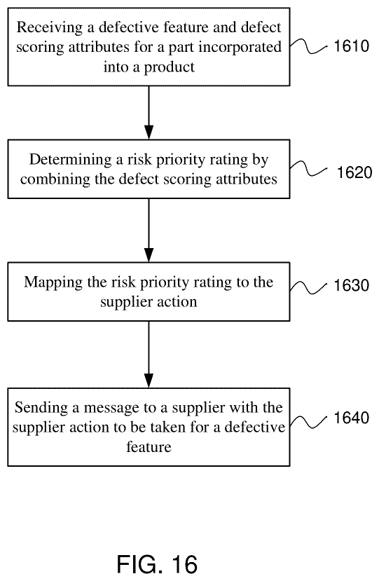

FIG. 16 is a flowchart illustrating a method of communicating a supplier action selected for defective feature/defect correction in a manufacturing channel. The method can include the operation of receiving a defective feature/defect data and risk attributes for a part incorporated into a product, as in block 1610. Additional information may also be received about the defective feature/defect, such as a defect condition (e.g., a defect condition value or label), a defect description, a defect code, a defect time and date or a defect photo.

Another operation can be determining a risk priority rating by combining the risk attributes, as in block 1620. The risk priority rating may be created by combining risk attributes that are a severity rating, a detection difficulty rating, an occurrence, performance attributes or other risk attributes for the defective features/defects. For example, the severity rating, the detection difficulty, and the occurrence can be numeric values. Accordingly, the risk priority rating may be determined by adding, multiplying or applying a numeric function (e.g., an algebraic function, a logarithmic function, etc.) to obtain the value. Alternatively, the severity rating, the detection difficulty, the occurrence or other quality ratings may be indexed together to provide the risk priority rating using a two dimensional, three-dimensional or N-dimensional index.

In one embodiment, weighting factors may be included with the risk attributes, and the weighting factors may be used where multiple defective features/defects are being aggregated and analyzed at a higher point in the supply chain. For example, the weighting parameter may be used with the detectability, severity and occurrence for the combination of multiple defective features/defects that may have varying levels of importance to the group of defective features/defects. Thus, a risk priority weighting may be provided for an aggregate group of defective features/defects, group of parts, or an entire product using weighting with the defective features/defects.

The risk priority rating may be mapped to the supplier action using a mapping function. The mapping function may be performed by determining a risk priority rating range within which the risk priority rating is classified, as in block 1630. There may be plurality of risk priority rating ranges with associated supplier actions for correcting defective features/defects. This range selection function may be considered a stepwise mapping function. Other types of mapping functions may also be used that continuous functions, custom mapping functions, etc. The supplier action may be: i) no action, ii) supplier containment with no approval from customer, iii) a supplier containment with approval from customer, iv) a supplier containment and fix cause with input from customer needed, or v) a supplier containment, fix cause and application of a CAR/8D process with input from customer.

Then a message may be sent to a supplier with the supplier action to be taken for a defective feature/defect, as in block 1640. The message may be sent by notifying a supplier device or a manufacturing device of a defective feature/defect using any one of a number of communication protocols, such as: an application notification, an SMS message, an instant message, an email, Message Queue Telemetry Transport (MQTT), RESTful API protocol, a remote procedure call, Hypertext Transfer Protocol (HTTP), or any other protocol that communicates packetized data.

In one configuration, the message may be sent to an IoT manufacturing machine (in addition to or instead of a message to the supplier) regarding a defective feature/defect associated with the supplier action in order to instruct the manufacturing machine to perform a supplier action or remedial action. So, for example, the remedial action may be operations such as: suspending manufacturing, displaying a defective feature/defect message to an operator on a screen on or near the IoT manufacturing machine, modifying a physical action of the manufacturing machine, modifying a defect detection process of the manufacturing machine or other actions the IoT manufacturing machine may be capable of taking.

In some situations, the defective feature data and risk attributes may be received or retrieved from an IoT manufacturing machine, supplier machine or another sensor device that provides a defective feature report after receiving information from the machine's sensors. The defective feature report may be: a report of part defects from a sensor at the IoT manufacturing machine or identifying part defects in images of parts captured by a camera or X-ray machine associated with the machine.

Not only can the IoT manufacturing machine report errors or information from sensors but quality control images and instructions may be sent to the IoT manufacturing machine. For example, an image of a defective feature/defect can be sent from the customer or quality control personnel to the IoT manufacturing machine. The image may include a marked inspection area and instructions to the manufacturing device to search for the defective feature/defect in the marked inspection area of later images of parts being inspected.

Trending test data representing part defective features/defects may also be sent to the supplier. The trending defect data may represent a time period such as a week, a month, a quarter, a year, etc. The trending test data may be depicted in graphs such a stacked pareto chart, a first pass yield (FPY) chart or other charts that may represent the trending data.

Messages from devices associated with the supplier may be monitored by a monitoring service to determine when a completion of a supplier action actions or to determine a missed response to a supplier action. Similarly, the effectiveness of a supplier's action may be monitored or tracked and then supplier actions may be flagged as ineffective when a defective feature/defect is received in a message prior to an action completion date for the supplier action. The supplier action levels can also be displayed in a graphical chart as compared to a number of occurrences of defective features/defects for each part defect over a plurality of defined time periods or weeks (see FIG. 9).

This technology may provide rapid feedback to a supplier in a manufacturing process. The automated feedback and monitoring may reduce human intervention during the notification and monitoring process. Suppliers can be notified immediately about defective features/defects that are being identified by a customer. Once a supplier has received a defect notification, changes may be made to the supplier's manufacturing devices immediately. Immediate action by the customer's machines or devices may avoid further defective parts being built by the supplier and avoid defective parts being sent to customer.

This technology allows the customer to spend engineering time on what is important and what should be addressed at any time, as opposed to spending significant amounts of time reporting defective features/defects and monitoring whether supplier actions are being taken. The score card (FIG. 10) is a high level overview of what is happening at any point in time with respect to supplier actions. Quality may be improved by intervening quickly to help correct the issues at the supplier. In addition, overall productivity may be increased due to defect prevention and root cause prioritization without consuming increased amounts of engineering time.

The technology allows a customer to communicate with suppliers in a way that increases response time to the suppliers for problems. The suppliers can then respond to a coded performance expectation. This means there is a lower time delay for feedback from the customer(s) (e.g., primary manufacturer) of the assembled product.

In one embodiment of this technology, the system may identify part upgrades, part design changes or part structure changes that are to be sent to a supplier. The supplier may send these upgrades electronically and then the changes may be implemented in the parts specified. Such part upgrades may be sent to the IoT manufacturing machines and changes to parts may occur in an automated fashion through the machines without human intervention. Performance attributes may also be considered an improvement rather than a deficiency, and the improvement of the performance attributes may be used to improve parts or manufacturing processes instead of correct defective features/defects.

In some embodiments, the method for communicating a supplier action selected for defective feature correction comprises alternative steps. Such steps may comprise retrieving, from a data store, defective feature data and risk attributes associated with a defect identified in a first component of a product, determining a risk priority rating for the defect based on the risk attributes, mapping the risk priority rating to the supplier action using a mapping function to select the supplier action for correcting the defect from a plurality of supplier actions for correcting the defect based on the defective feature data and the risk attributes associated with the defect, and automatically communicating a first electronic message to a supplier system, the first electronic message including the supplier action to be performed to correct the defect in the component and at least a portion of the defective feature data.

In some configurations, the method may further comprise monitoring messaging and subsequent components from the supplier system to determine completion of the supplier action or a missed response to the supplier action. The monitoring of messaging and subsequent components from the supplier system may comprise, receiving a second message from the supplier system providing an initial completion date by which the supplier action will be implemented, receiving a second component from the supplier system, and determining whether the data store includes defective feature data and risk attributes associated with a same defect identified in the first component for the second component. When the data store does not include defective feature data and risk attributes associated with the same defect for the second component, the monitoring further comprises flagging the supplier action as effective. When the data store does include defective feature data and risk attributes associated with the same defect for the second component, the monitoring further comprises flagging the supplier action as ineffective, requesting a new completion date from the supplier system when the data store includes the defective feature and risk attributes associated with the same defect for the second component prior to the initial completion date.

The risk priority rating may be created by combining risk attributes that are a severity rating, a detection difficulty rating, and occurrence for a defective feature. The risk attributes of the severity rating, the detection difficulty, and the occurrence may be numeric values. The risk priority rating may be determined by adding, multiplying or indexing at least two of: the severity rating, the detection difficulty and the occurrence.

In some occurrences, the mapping function comprises: identifying a plurality of risk priority rating ranges associated with the plurality of supplier actions for correcting defect and determining a risk priority rating range within which the risk priority rating is classified. Automatically communicating a first electronic message to a supplier system may comprise communicating the first electronic message to an IoT (Internet of Things) manufacturing machine to instruct the IoT manufacturing machine to perform a remedial action associated with the supplier action. The remedial action may be at least one of: suspending manufacturing, displaying a defect message to an operator, modifying a physical action of the IoT manufacturing machine, or modifying a defect detection process of the IoT manufacturing machine. The first and second electronic message may comprise at least one of: an application notification, an SMS message, an instant message, an email, Message Queue Telemetry Transport (MQTT) protocol, RESTful API protocol, or Hypertext Transfer Protocol (HTTP).

The defective feature data may include at least one of: a defective feature, a defect condition, a defect description, a defect code or a defect photo. The defective feature data may be retrieved from the IoT manufacturing machine that provides a defective feature report after receiving at least one of: an identification of the defect using a sensor at the IoT manufacturing machine or identifying the defect in an image of the component during manufacturing. Automatically communicating the first electronic message including at least a portion of the defective feature data may comprise sending an image of the component and the defect including a marked inspection area and instructions to the IoT manufacturing machine to enable searching for the defect in the marked inspection area. Supplier action levels may be displayed in a graphical chart as compared to a number of occurrences for the defect over a plurality of defined time periods.

Though the steps and aspects of the methods above may not be shown explicitly in FIG. 16, they may be similarly performed or enabled by the technologies described herein.

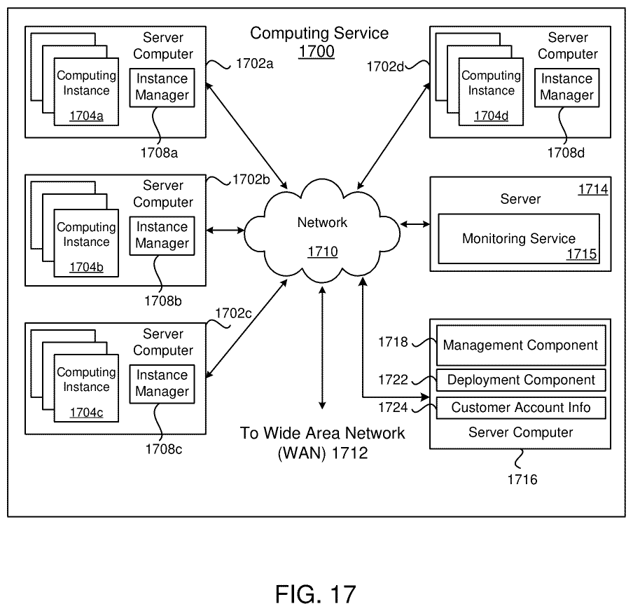

FIG. 17 is a block diagram illustrating an example computing service 1700 that may be used to execute and manage a number of computing instances 1704a-d upon which the present technology may execute. In particular, the computing service 1700 depicted illustrates one environment in which the technology described herein may be used. The computing service 1700 may be one type of environment that includes various virtualized service resources that may be used, for instance, to host computing instances 1704a-d.

The computing service 1700 may be capable of delivery of computing, storage and networking capacity as a software service to a community of end recipients. In one example, the computing service 1700 may be established for an organization by or on behalf of the organization. That is, the computing service 1700 may offer a “private cloud environment.” In another example, the computing service 1700 may support a multi-tenant environment, wherein a plurality of customers may operate independently (i.e., a public cloud environment). Generally speaking, the computing service 1700 may provide the following models: Infrastructure as a Service (“IaaS”) and/or Software as a Service (“SaaS”). Other models may be provided. For the IaaS model, the computing service 1700 may offer computers as physical or virtual machines and other resources. The virtual machines may be run as guests by a hypervisor, as described further below. The PaaS model delivers a computing system that may include an operating system, programming language execution environment, database, and web server.

Application developers may develop and run their software solutions on the computing service system without incurring the cost of buying and managing the underlying hardware and software. The SaaS model allows installation and operation of application software in the computing service 1700. End customers may access the computing service 1700 using networked client devices, such as desktop computers, laptops, tablets, smartphones, etc. running web browsers or other lightweight client applications, for example. Those familiar with the art will recognize that the computing service 1700 may be described as a “cloud” environment.

The particularly illustrated computing service 1700 may include a plurality of server computers 1702a-d. The server computers 1702a-d may also be known as physical hosts. While four server computers are shown, any number may be used, and large data centers may include thousands of server computers. The computing service 1700 may provide computing resources for executing computing instances 1704a-d. Computing instances 1704a-d may, for example, be virtual machines. A virtual machine may be an instance of a software implementation of a machine (i.e. a computer) that executes applications like a physical machine. In the example of a virtual machine, each of the server computers 1702a-d may be configured to execute an instance manager 1708a-d capable of executing the instances. The instance manager 1708a-d may be a hypervisor, virtual machine manager (VMM), or another type of program configured to enable the execution of multiple computing instances 1704a-d on a single server. Additionally, each of the computing instances 1704a-d may be configured to execute one or more applications.

A server 1714 may be reserved to execute software components for implementing the present technology or managing the operation of the computing service 1700 and the computing instances 1704a-d. For example, the server 1714 may include a monitoring service 1715. The monitoring service 1715 may receive messages from the suppliers (such as the supplier 162 or supplier devices 160 of FIG. 1) such as messages regarding completion of remediation or messages regarding non-complaint or ineffective remediation. The monitoring service 1715 may also include any of the functionality described for the monitoring service in FIG. 1.

A server computer 1716 may execute a management component 1718. A customer may access the management component 1718 to configure various aspects of the operation of the computing instances 1704a-d purchased by a customer. For example, the customer may setup computing instances 1704a-d and make changes to the configuration of the computing instances 1704a-d.

A deployment component 1722 may be used to assist customers in the deployment of computing instances 1704a-d. The deployment component 1722 may have access to account information associated with the computing instances 1704a-d, such as the name of an owner of the account, credit card information, country of the owner, etc. The deployment component 1722 may receive a configuration from a customer that includes data describing how computing instances 1704a-d may be configured. For example, the configuration may include an operating system, provide one or more applications to be installed in computing instances 1704a-d, provide scripts and/or other types of code to be executed for configuring computing instances 1704a-d, provide cache logic specifying how an application cache is to be prepared, and other types of information. The deployment component 1722 may utilize the customer-provided configuration and cache logic to configure, prime, and launch computing instances 1704a-d. The configuration, cache logic, and other information may be specified by a customer accessing the management component 1718 or by providing this information directly to the deployment component 1722.

Customer account information 1724 may include any desired information associated with a customer of the multi-tenant environment. For example, the customer account information may include a unique identifier for a customer, a customer address, billing information, licensing information, customization parameters for launching instances, scheduling information, etc. As described above, the customer account information 1724 may also include security information used in encryption of asynchronous responses to API requests. By “asynchronous” it is meant that the API response may be made at any time after the initial request and with a different network connection.

A network 1710 may be utilized to interconnect the computing service 1700 and the server computers 1702a-d, 1716. The network 1710 may be a local area network (LAN) and may be connected to a Wide Area Network (WAN) 1712 or the Internet, so that end customers may access the computing service 1700. In addition, the network 1710 may include a virtual network overlaid on the physical network to provide communications between the server computers 1702a-d.

Though not described explicitly, various aspects of the methods and systems described herein may be implemented by aspects of the computing service 1700. For example, the automated flow of FIG. 2 or the server or computing service 135 of FIG. 1, among other features described herein, may be implemented by the computing service 1700 of FIG. 17.

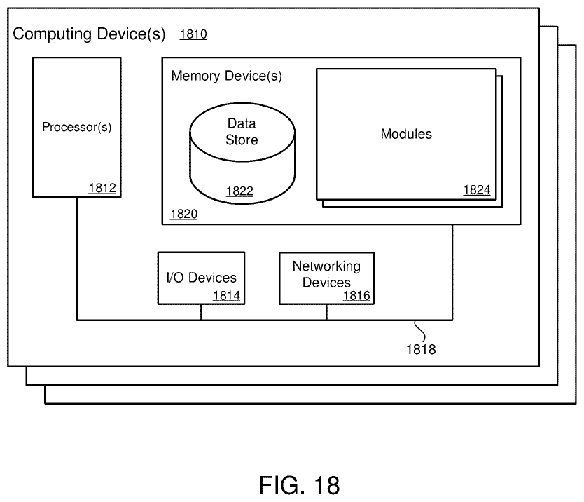

FIG. 18 illustrates a computing device 1810 which may execute the foregoing subsystems of this technology. The computing device 1810 and the components of the computing device 1810 described herein may correspond to the servers and/or client devices described above. The computing device 1810 is illustrated on which a high level example of the technology may be executed. The computing device 1810 may include one or more processors 1812 that are in communication with memory devices 1820. The computing device may include a local communication interface 1818 for the components in the computing device. For example, the local communication interface may be a local data bus and/or any related address or control busses as may be desired.

The memory device 1820 may contain modules 1824 that are executable by the processor(s) 1812 and data for the modules 1824. The modules 1824 may execute the functions described earlier. A data store 1822 may also be located in the memory device 1820 for storing data related to the modules 1824 and other applications along with an operating system that is executable by the processor(s) 1812.

Other applications may also be stored in the memory device 1820 and may be executable by the processor(s) 1812. Components or modules discussed in this description that may be implemented in the form of software using high programming level languages that are compiled, interpreted or executed using a hybrid of the methods.

The computing device may also have access to I/O (input/output) devices 1814 that are usable by the computing devices. An example of an I/O device is a display screen that is available to display output from the computing devices. Other known I/O device may be used with the computing device as desired. Networking devices 1816 and similar communication devices may be included in the computing device. The networking devices 1816 may be wired or wireless networking devices that connect to the internet, a LAN, WAN, or other computing network.

The components or modules that are shown as being stored in the memory device 1820 may be executed by the processor 1812. The term “executable” may mean a program file that is in a form that may be executed by a processor 1812. For example, a program in a higher level language may be compiled into machine code in a format that may be loaded into a random access portion of the memory device 1820 and executed by the processor 1812, or source code may be loaded by another executable program and interpreted to generate instructions in a random access portion of the memory to be executed by a processor. The executable program may be stored in any portion or component of the memory device 1820. For example, the memory device 1820 may be random access memory (RAM), read only memory (ROM), flash memory, a solid state drive, memory card, a hard drive, optical disk, floppy disk, magnetic tape, or any other memory components.

The processor 1812 may represent multiple processors and the memory device 1820 may represent multiple memory units that operate in parallel to the processing circuits. This may provide parallel processing channels for the processes and data in the system. The local communication interface 1818 may be used as a network to facilitate communication between any of the multiple processors and multiple memories. The local communication interface 1818 may use additional systems designed for coordinating communication such as load balancing, bulk data transfer, and similar systems.

Some of the functional units described in this specification have been depicted as blocks or modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more sections of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method of communicating a supplier action selected for defective feature correction, comprising:
retrieving, from a data store, defective feature data and risk attributes associated with a defect identified in a first component of a product;
determining a risk priority rating for the defect based on the risk attributes;
mapping the risk priority rating to the supplier action using a mapping function to select the supplier action for correcting the defect from a plurality of supplier actions for correcting the defect based on the defective feature data and the risk attributes associated with the defect; and
automatically communicating a first electronic message to a supplier system, the first electronic message including the supplier action to be performed to correct the defect in the first component, and to an IoT (Internet of Things) manufacturing machine to instruct the IoT manufacturing machine to perform a remedial action associated with the supplier action.

2. The method as in claim 1, further comprising:
monitoring messaging and subsequent components from the supplier system to determine completion of the supplier action or a missed response to the supplier action.

3. The method as in claim 2, wherein the monitoring of messaging and subsequent components from the supplier system comprises:
receiving a second message from the supplier system providing an initial completion date by which the supplier action will be implemented;
receiving a second component from the supplier system;
determining whether the data store includes defective feature data and risk attributes associated with a same defect identified in the first component for the second component;
when the data store does not include defective feature data and risk attributes associated with the same defect for the second component, flagging the supplier action as effective; and
when the data store does include defective feature data and risk attributes associated with the same defect for the second component,
flagging the supplier action as ineffective; and
requesting a new completion date from the supplier system when the data store includes the defective feature and risk attributes associated with the same defect for the second component prior to the initial completion date.

4. The method as in claim 1, wherein the risk priority rating is created by combining risk attributes that are a severity rating, a detection difficulty rating, and occurrence for a defective feature.

5. The method as in claim 4, wherein the risk attributes of the severity rating, the detection difficulty, and the occurrence are numeric values.

6. The method as in claim 4, wherein the risk priority rating is determined by adding, multiplying or indexing at least two of: the severity rating, the detection difficulty and the occurrence.

7. The method as in claims 1, wherein the mapping function comprises:
identifying a plurality of risk priority rating ranges associated with the plurality of supplier actions for correcting defect; and
determining a risk priority rating range within which the risk priority rating is classified.

8. The method as in claims 1, wherein the supplier action is at least one of: i) no action, ii) supplier containment with no approval from customer, iii) supplier containment with approval from customer, iv) supplier containment and fix cause with input from customer needed, or v) supplier containment, fix cause and application of a CAR/8D process with input from customer.

9. (canceled)

10. The method as in claim 1, wherein the remedial action is at least one of: suspending manufacturing, displaying a defect message to an operator, modifying a physical action of the IoT manufacturing machine, or modifying a defect detection process of the IoT manufacturing machine.

11. The method as in claims 1, wherein the first electronic message comprises at least one of: an application notification, an SMS message, an instant message, an email, Message Queue Telemetry Transport (MQTT) protocol, RESTful API protocol, or Hypertext Transfer Protocol (HTTP).

12. The method as in claims 1, further comprising communicating trending test data to the supplier.

13. The method as in claim 12, wherein the trending test data is a stacked pareto chart or a first pass yield (FPY) chart.

14. The method as in claims 1, wherein the defective feature data includes at least one of: a defective feature, a defect condition, a defect description, a defect code or a defect photo.

15. The method as in claim 1, wherein the defective feature data is retrieved from the IoT manufacturing machine that provides a defective feature report after receiving at least one of: an identification of the defect using a sensor at the IoT manufacturing machine or identifying the defect in an image of the component during manufacturing.

16. The method as in claims 1, wherein supplier action levels are displayed in a graphical chart as compared to a number of occurrences for the defect over a plurality of defined time periods.

17. The method as in claim 1, wherein automatically communicating the first electronic message including at least a portion of the defective feature data comprises sending an image of the component and the defect including a marked inspection area and instructions to the IoT manufacturing machine to enable searching for the defect in the marked inspection area.

18. A machine readable storage medium having instructions embodied thereon, the instructions when executed by one or more processors, being configured to communicate a supplier action selected for defective feature correction and cause the one or more processors to perform a process comprising:
retrieving, from a data store, defective feature data and risk attributes associated with a defect identified in a first component of a product;
determining a risk priority rating for the defect based on the risk attributes;
mapping the risk priority rating to the supplier action using a mapping function to select the supplier action for correcting the defect from a plurality of supplier actions for correcting the defect based on the defective feature data and the risk attributes associated with the defect; and
automatically communicating a first electronic message to a supplier system, the first electronic message including the supplier action to be performed to correct the defect in the first component, and to an IoT (Internet of Things) manufacturing machine to instruct the IoT manufacturing machine to perform a remedial action associated with the supplier action.

19. The machine readable storage medium as in claim 18, further comprising monitoring messaging and subsequent components from the supplier system to determine completion of the supplier action or a missed response to the supplier action.

20. The machine readable storage medium as in claim 19, wherein the monitoring of messaging and subsequent components from the supplier system comprises:
receiving a second message from the supplier system providing an initial completion date by which the supplier action will be implemented;
receiving a second component from the supplier system;
determining whether the data store includes defective feature data and risk attributes associated with a same defect identified in the first component for the second component; and
when the data store does not include defective feature data and risk attributes associated with the same defect for the second component, flagging the supplier action as effective; and
when the data store does include defective feature data and risk attributes associated with the same defect for the second component,
flagging the supplier action as ineffective;
requesting a new completion date from the supplier system when the data store includes the defective feature and risk attributes associated with the same defect for the second component prior to the initial completion date.

21. The machine readable storage medium as in claim 18, wherein the risk priority rating is created by combining risk attributes that are a severity rating, a detection difficulty rating and occurrence for the defective feature.

22. The machine readable storage medium as in claim 21, wherein the severity rating, detection difficulty, and occurrence are numeric values.

23. The machine readable storage medium as in claims 21, wherein the risk priority rating is determined by adding, multiplying or indexing at least two of: the severity rating, detection difficulty and occurrence.

24. The machine readable storage medium as in claims 18, wherein the mapping function comprises:
identifying a plurality of risk priority rating ranges associated with the plurality of supplier actions for correcting defect; and
determining a risk priority rating range within which the risk priority rating is classified.

25. The machine readable storage medium as in claims 18, wherein the supplier action is at least one of: i) no action, ii) supplier containment with no approval from customer, iii) supplier containment with approval from customer, iv) supplier containment and fix cause with input from customer needed, or v) a supplier containment, fix cause and application of a CAR/8D process with input from customer.

26. (canceled)

27. The machine readable storage medium as in claim 18, wherein the remedial action is at least one of: suspending manufacturing, displaying a defect message to an operator, modifying a physical action of the IoT manufacturing machine, or modifying a defect detection process of the IoT manufacturing machine.

28. The machine readable storage medium as in claims 18, wherein the first electronic message comprises at least one of: an application notification, an SMS message, an instant message, an email, Message Queue Telemetry Transport (MQTT) protocols, RESTful API protocol, or Hypertext Transfer Protocol (HTTP).

29. The machine readable storage medium as in claims 18, further comprising communicating trending test data analysis to the supplier.

30. The machine readable storage medium as in claim 29, wherein the trending test data is a stacked pareto chart or a first pass yield (FPY) chart.

31. The machine readable storage medium as in claim 18, wherein the defective feature data includes at least one of: defective feature, a defect condition, a defect description, a defect code or a defect photo.

32. The machine readable storage medium as in claim 18, wherein the defective feature data is retrieved from the IoT manufacturing machine that provides a defective feature report after receiving at least one of: an identification of the defect using a sensor at the IoT manufacturing machine or identifying the defect in an image of the component during manufacturing.

33. The machine readable storage medium as in claims 18, wherein supplier action levels are displayed in a graphical chart as compared to a number of occurrences for the defect over a plurality of defined time periods.

34. The machine readable storage medium as in claim 18, wherein automatically communicating the first electronic message including at least a portion of the defective feature data comprises sending an image of the component and the defect including a marked inspection area and instructions to the IoT manufacturing machine to enable searching for the defect in the marked inspection area.

35. A method for displaying supplier response to a defective part notification using a graphical user interface, comprising:
identifying defective feature data associated with a defect in a part used in assembling a product;
displaying an action completion date as a calendar due date for a supplier action for correcting the defect;
applying an action state color to the calendar due date for the supplier action for display with the calendar due date;
receiving a first message from a supplier system at a monitoring service, the first message indicating that the supplier action has been completed;
updating the action state color displayed with the calendar due date to an action completed color based on the indication that the supplier system completed the supplier action as directed by the monitoring service;
identifying, at the monitoring service, additional defective feature data indicating that another defect occurred after the action completion date; and
updating the action state color displayed with the calendar due date to an action ineffective color based on the additional defective feature data as directed by the monitoring service.

36. The method as in claim 35, wherein the supplier action is at least one of:
containment of the defect, fixing of a cause of the defect or applying a manufacturing quality control process.

37. (canceled)

38. The method as in claim 35, wherein the action ineffective color is red.

39. The method as in claims 35, wherein the action state color is yellow and the action completed color is green.

40. The method as in claims 35, further comprising:
determining when the calendar due date has passed without receiving the first message, using the monitoring service; and
updating the action state color displayed with the calendar due date to an action not submitted color based on not receiving the first message before the calendar due date passed.

41. The method as in claim 40, wherein the action not submitted color is red.

42. The method as in claims 35, further comprising displaying, along with the calendar due date, a supplier action level, a supplier action description, and a subset of the defective feature data associated with the part defect.

43. The method as in claims 35, wherein the calendar due date is initially determined based on a current date plus a number of days allowed for implementing the supplier action.

44. A method for managing a plurality of suppliers that supply parts for a product using a graphical user interface, comprising:
identifying a plurality of defective features of the product for which suppliers have been assigned supplier actions;
determining a supplier maturity metric for a supplier of the plurality of suppliers using risk priority ratings for a subset of the plurality of defective features associated with the supplier;
displaying a tree graph, wherein a node of the tree graph represents the supplier of at least one part for the product and an edge of the tree graph represents a product part movement between tiers or levels of suppliers;
displaying the supplier maturity metric and a graphical user interface control associated with the supplier; and
receiving an activation of the graphical user interface control to initiate a remedial action associated with the supplier.

45. The method as in claim 44, wherein the graphical user interface control initiates the remedial action that is halting of further shipments of a part from a supplier.

46. The method as in claims 44, wherein the graphical user interface control initiates the remedial action that is sending a message to a supplier to stop shipments.

47. The method as in claims 44, wherein the graphical user interface control can initiate the remedial action that is stopping of further manufacturing of a part.

48. The method as in claims 44, further comprising sending a message to an IoT manufacturing machine to stop manufacturing a part upon activation of the graphical user interface control.

49. The method as in claims 44, wherein the graphical user interface control can initiate the remedial action that is presenting an alternative supplier that can be selected to provide parts in place of a supplier.

50. The method as in claim 49, further comprising:
receiving a selection of the alternative supplier for a part;
sending a first notification to the alternative supplier to increase part production; and
sending a second notification to the supplier to decrease part production.
